(19) United States
(12) Patent Application Publication
(10) Pub. No.: US 2019/0137720 A1
(43) Pub. Date: May 9, 2019

(54) FIBER AND CONDUIT INSTALLATION AND STAGING APPARATUSES

(71) Applicant: George Nicholson, Burlington, WY (US)

(72) Inventor: George Nicholson, Burlington, WY (US)

(21) Appl. No.: 16/185,895

(22) Filed: Nov. 9, 2018

Related U.S. Application Data
(60) Provisional application No. 62/583,976, filed on Nov. 9, 2017.

(51) Int. Cl. G02B 6/50; A01D 34/64; A01D 42/00

(52) U.S. Cl. CPC G02B 6/504; A01D 42/00; A01D 34/64

(57) ABSTRACT

A fiber and conduit installation machine includes a support vehicle, a rear structure, and an installation and staging apparatus. The rear structure is mechanically attached to a first end of the support vehicle. The apparatus includes a support structure, first and second cylindrical structures, and an interface. The support structure includes a fixed portion and a movable portion. The first cylindrical structure mechanically coupled to the support structure. The first cylindrical structure rotates relative to the support vehicle. The second cylindrical structure mechanically coupled to the support structure and configured to be driven to rotate and to traverse relative to the support structure. The interface is created between portions of circumferential surfaces of the first and second cylindrical structures. The interface is created through traversal of the second cylindrical structure relative to the first cylindrical structure. Mechanical rotation of the second cylindrical structure causes rotation of the first cylindrical structure.

### CROSS REFERENCE TO RELATED APPLICATION

This application claims the benefit and priority to U.S. provisional application No. 62/583,976 filed Nov. 9, 2017, which is incorporated herein by reference in its entirety.

### FIELD

The embodiments discussed herein are related to fiber and conduit installation and staging apparatuses.

### BACKGROUND

Currently multiple devices and processes are used in installation of fiber optic cables (hereinafter, “fiber”) and conduit that houses the fiber. In some circumstances, fiber and conduit are installed using a direct bury process. In the direct bury process, a trench is dug by one or more workers. The trench must not bend more than the bending radius of the fiber. The fiber and/or the conduit are then laid in the trench and covered.

The subject matter claimed herein is not limited to embodiments that solve any disadvantages or that operate only in environments such as those described above. Rather, this background is only provided to illustrate one example technology area where some embodiments described herein may be practiced.

### SUMMARY

An aspect of the invention includes an optical fiber installation and staging apparatus that is configured to perform several functions related to installation of optical fiber and/or conduit. The apparatus may include several components such as a base, a support structure, a first cylindrical structure, a second cylindrical structure, a guidance arm, a guidance structure, an interface, a hydraulic motor, a turntable, a third cylindrical structure, a pneumatic installer, a mower, a FIGURE-EIGHT guide, and a leveling subsystem. The support structure may be coupled to the base and may include a fixed portion and a movable portion. The first cylindrical structure may be mechanically coupled to the fixed portion of the support structure. The first cylindrical structure may be configured to rotate relative to the support structure. The second cylindrical structure may be mechanically coupled to the movable portion. The second cylindrical structure may be configured to be mechanically rotated relative to the support structure and to traverse relative to the fixed portion of the support structure. The guidance arm may be mechanically coupled to the fixed portion of the support structure. The guidance structure may be positioned on the guidance arm. The interface may be created between at least a portion of a circumferential surface of the second cylindrical structure and at least a portion of a circumferential surface of the first cylindrical structure. The guidance structure may be configured to receive an optical fiber or a conduit. The second cylindrical structure may be configured to traverse towards the first cylindrical structure to receive the optical fiber or the conduit in the interface. Mechanical rotation of the second cylindrical structure may cause rotation of the first cylindrical structure and a lateral motion of the optical fiber or the conduit received in the interface through the guidance structure. The hydraulic motor may be coupled to an axel of the second cylindrical structure and may be configured to cause the mechanical rotation of the first cylindrical structure. The turntable enables a rotational positioning of the first and second cylindrical structures relative to a support vehicle. The turntable may be fixed to the base and includes a rotational gear that is driven by a hydraulic motor.

The third cylindrical structure may be positioned relative to the second cylindrical structure such that a second interface is created between the third cylindrical structure and the second cylindrical structure. Axles of the first cylindrical structure, the second cylindrical structure, and the third cylindrical structure are substantially parallel. In detail, the optical fiber or the conduit may be drawn from a source, routed over the third cylindrical structure, through the second interface, through the interface between the first and the second cylindrical structures, received in the guidance structure, and to a destination. The mechanical rotation may draw the optical fiber or the conduit from the source to the destination. The guidance structure may be configured to oscillate relative to the guidance arm from a first rotational position to a second rotational position. The FIGURE-EIGHT guide may be configured to extend from the support structure. The FIGURE-EIGHT guide may include an adaptor that is configured to be received by the guidance structure and the FIGURE-EIGHT guide may define a volume in which a fiber or a conduit is positioned during a FIGURE-EIGHT staging process. The second cylindrical structure may be configured to drive a particular length of the optical fiber or the conduit as the guidance structure oscillates from the first rotational position to the second rotational position such that the fiber or the conduit is laid in a FIGURE-EIGHT pattern on a surface surrounding the apparatus. The pneumatic installer may define a central volume in which the optical fiber or the conduit is positioned. The pneumatic installer may be configured to receive a pneumatic pressure and apply the pressure to the optical fiber or the conduit. The mower may be coupled to a bottom surface of the base such that an environmental vegetation enters a housing surrounding the mower and interfaces with a rotating blade of the mower. The base may be rotationally coupled to the support structure and the leveling subsystem may be configured to rotate the support structure relative to the base.

Another aspect of the invention includes a fiber and conduit installation machine that may include a support vehicle, a rear structure mechanically attached to a first end of the support vehicle, a controller computer, and an optical fiber installation and staging apparatus attached to a second end of the support vehicle. The apparatus may include several components such as a base, a support structure, a first cylindrical structure, a second cylindrical structure, a guidance arm, a guidance structure, an interface, a hydraulic motor, a turntable, a third cylindrical structure, a pneumatic installer, a mower, a FIGURE-EIGHT guide, and a leveling subsystem. The support structure may be coupled to the base and may include a fixed portion and a movable portion. The first cylindrical structure may be mechanically coupled to the fixed portion of the support structure. The first cylindrical structure may be configured to rotate relative to the support structure. The second cylindrical structure may be mechanically coupled to the movable portion. The second cylindrical structure may be configured to be mechanically rotated relative to the support structure and to traverse relative to the fixed portion of the support structure. The guidance arm may be mechanically coupled to the fixed portion of the support structure. The guidance structure may be positioned on the guidance arm. The interface may be created between at least a portion of a circumferential surface of the second cylindrical structure and at least a portion of a circumferential surface of the first cylindrical structure. The guidance structure may be configured to receive an optical fiber or a conduit. The second cylindrical structure may be configured to traverse towards the first cylindrical structure to receive the optical fiber or the conduit in the interface. Mechanical rotation of the second cylindrical structure may cause rotation of the first cylindrical structure and a lateral motion of the optical fiber or the conduit received in the interface through the guidance structure. The hydraulic motor may be coupled to an axel of the second cylindrical structure and may be configured to cause the mechanical rotation of the first cylindrical structure. The turntable enables a rotational positioning of the first and second cylindrical structures relative to a support vehicle. The turntable may be fixed to the base and includes a rotational gear that is driven by a hydraulic motor. The third cylindrical structure may be positioned relative to the second cylindrical structure such that a second interface is created between the third cylindrical structure and the second cylindrical structure. Axles of the first cylindrical structure, the second cylindrical structure, and the third cylindrical structure are substantially parallel. In detail, the optical fiber or the conduit may be drawn from a source, routed over the third cylindrical structure, through the second interface, through the interface between the first and the second cylindrical structures, received in the guidance structure, and to a destination. The mechanical rotation may draw the optical fiber or the conduit from the source to the destination. The guidance structure may be configured to oscillate relative to the guidance arm from a first rotational position to a second rotational position. The FIGURE-EIGHT guide may be configured to extend from the support structure. The FIGURE-EIGHT guide may include an adaptor that is configured to be received by the guidance structure and the FIGURE-EIGHT guide may define a volume in which a fiber or a conduit is positioned during a FIGURE-EIGHT staging process. The second cylindrical structure may be configured to drive a particular length of the optical fiber or the conduit as the guidance structure oscillates from the first rotational position to the second rotational position such that the fiber or the conduit is laid in a FIGURE-EIGHT pattern on a surface surrounding the apparatus. The pneumatic installer may define a central volume in which the optical fiber or the conduit is positioned. The pneumatic installer may be configured to receive a pneumatic pressure and apply the pressure to the optical fiber or the conduit. The mower may be coupled to a bottom surface of the base such that an environmental vegetation enters a housing surrounding the mower and interfaces with a rotating blade of the mower. The base may be rotationally coupled to the support structure and the leveling subsystem may be configured to rotate the support structure relative to the base. The rear support may include a D-ring into which the optical fiber or the conduit is positioned prior to routing through the interface. The apparatus may include a third cylindrical structure that may be coupled to the rear structure and oriented at about 90 degrees relative to the first and second cylindrical structures. The optical fiber and the conduit may be routed around a portion of the second cylindrical structure and through the interface. The controller computer that is configured to control a position of the first and second cylindrical structure and a rotational speed of the second cylindrical structure.

Yet another aspect of the invention includes a fiber and conduit installation machine that may include a support vehicle, a rear structure, an optical fiber installation and staging apparatus, a turntable, a third cylindrical structure, an oscillation device, a guidance arm, a guidance structure, and a FIGURE-EIGHT guide. The rear structure may be mechanically attached to a first end of the support vehicle. The optical fiber installation and staging apparatus may include a support structure, multiple cylindrical structures, and an interface. The support structure may include a fixed portion and a movable portion. A first cylindrical structure may be mechanically coupled to the support structure. The first cylindrical structure may be configured to rotate relative to the support vehicle. A second cylindrical structure may be mechanically coupled to the support structure. The second cylindrical structure may be configured to be driven to rotate relative to the support vehicle and to traverse relative to the support structure. The interface may be created between at least a portion of a circumferential surface of the second cylindrical structure and at least a portion of a circumferential surface of the first cylindrical structure. The interface may be created through traversal of the second cylindrical structure relative to the first cylindrical structure. Mechanical rotation of the second cylindrical structure may cause rotation of the first cylindrical structure. The turntable may enable a rotational positioning of the first and second cylindrical structures relative to the support vehicle. The turntable may be fixed to a base and may include a rotational gear that is driven by a hydraulic motor. A third cylindrical structure may be positioned relative to the second cylindrical structure such that a second interface is created between the third cylindrical structure and the second cylindrical structure and rotation of the second cylindrical structure causes rotation of the third cylindrical structure. The oscillation device may have a positioner at one end. The third cylindrical structure may be configured to contact a spool such that rotation of the third cylindrical structure rotates the spool. As the spool rotates, oscillation of the oscillation device enables a substantially even distribution of an optical fiber or a conduit along a length of the spool. The guidance arm may be mechanically coupled to the support structure. The guidance structure may be positioned on the guidance arm. The guidance structure may be configured to oscillate relative to the guidance arm from a first rotational position to a second rotational position. The FIGURE-EIGHT guide may be configured to extend from the support structure. The FIGURE-EIGHT guide may include an adaptor that may be configured to be received by the guidance structure. The FIGURE-EIGHT guide may define a volume in which a fiber or a conduit is positioned during a FIGURE-EIGHT staging process. The second cylindrical structure may be configured to drive a particular length of the optical fiber or the conduit as the guidance structure oscillates from the first rotational position to the second rotational position such that the fiber or the conduit is laid in a FIGURE-EIGHT pattern on a surface surrounding the apparatus.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A illustrates an example fiber and conduit installation machine (machine);

FIG. 1B depicts an example controller computer that may be implemented in the machine of FIG. 1A;

FIGS. 2A-2D are schematic diagrams of an example apparatus that may be implemented in the machine of FIG. 1A;

FIGS. 3A and 3B are schematic diagrams of the rear structure that may be implemented in the machine of FIG. 1A;

FIG. 4 depicts a schematic diagram of an example drive function and arrangement of the machine or components thereof to perform the drive function;

FIG. 5 depicts a schematic diagram of an example manhole drive function and arrangement of the machine or components thereof to perform the manhole drive function;

FIG. 6 depicts a schematic diagram of an example corner drive function and arrangement of the machine or components thereof to perform the corner drive function;

FIG. 7A depicts a schematic diagram of an example pneumatic drive function and arrangement of the machine or components thereof to perform the corner drive function;

FIGS. 7B and 7C depict schematic diagrams of an example pneumatic installer that may be implemented during the pneumatic drive function;

FIG. 8 depicts a schematic diagram of an example FIGURE-EIGHT function and arrangement of the machine or components thereof to perform the FIGURE-EIGHT function;

FIGS. 9A-9D are block diagrams of an example guidance structure that may be implemented in the apparatus of FIG. 2A;

FIGS. 10A and 10B depict a schematic diagram of an example spooling function and arrangement of the machine or components thereof to perform the spooling function;

FIG. 10C depicts a schematic diagram of an example oscillation device that may be implemented in the spooling function;

FIG. 11 depicts a block diagram of a first rate adjustment function and arrangement of the machine or components thereof to perform the first rate adjustment function;

FIG. 12A depicts a block diagram of a second rate adjustment function and arrangement of the machine or components thereof to perform the second rate adjustment function;

FIG. 12B depicts a block diagram of the second rate adjustment function and alternative arrangement of the machine or components thereof to perform the second rate adjustment function;

FIG. 13 is a block diagram illustrating a mower function and arrangement of the machine or components thereof to perform the mower function; and

FIG. 14 is a block diagram of an example computing system that is configured for fiber and conduit installation and staging processes,

all in accordance with at least one embodiment described in this disclosure.

### DESCRIPTION OF SOME EXAMPLE EMBODIMENTS

As communication networks increase in scale and capability, the amount of optical fiber cables (hereinafter, “fiber”) and conduit increases. Moreover, as rural locations become connected with modern communication networks, the fiber and the conduit is installed in rural locations and between rural locations and urban locations. A majority of this installed fiber and conduit is installed below the surface of the ground. Multiple devices implement multiple processes to install the fiber and conduit. For example, in some circumstances, the fiber and conduit are installed using a direct-bury process. In the direct-bury process, a trench is dug. The fiber and the conduit are buried in the trench. Additionally, in some circumstances, a side-drilling process may be implemented to drill trenches at an angle below the sidewalk or another surface. The fiber and/or the conduit are then installed in the bore created during the side-drilling process. These installation processes suffer from several shortcomings. For instance, both involve substantial amounts of man power and require removal of large quantities of soil.

Accordingly, some embodiments described in this disclosure relate to a fiber and/or conduit installation and staging apparatus (hereinafter, “apparatus”). Some embodiments of the apparatus enable installation and staging of the fiber or the conduit (fiber/conduit) via two or more processes. A first installation process is a pneumatic process in which a pneumatic pressure is applied to the fiber/conduit. The fiber may then be blown into a conduit or the conduit may be blown through the earth or soil. In addition, these and other embodiments of the apparatus may mechanically advance the fiber/conduit by pinching the fiber/conduit between two cylindrical structures such as automotive tires. Example embodiments may use the pneumatic process to blow the fiber or conduit about a first mile or another suitable distance. Subsequently, the apparatus may mechanically advance the fiber/conduit about another mile or another suitable distance.

In addition, the cylindrical structures may be used to pull fiber or conduit. In particular, the cylindrical structures may be used to pull fiber/conduit between manholes. For example, a length of twenty miles of fiber may be installed along a section of highway with a manhole every two miles. The apparatus may be positioned near a first manhole and the fiber may be installed to the second manhole (e.g., such that an end of the fiber/conduit is at the second manhole). The apparatus may then be re-positioned at the second manhole. The apparatus may be attached to the end of the fiber/conduit and then pull the remaining fiber through the first section between the first manhole and the second manhole. Accordingly, the first two miles of the twenty-mile length of fiber may be positioned in the first section between the first manhole and the second manhole.

Some embodiments of the apparatus may include one or more staging components. A first staging component is a FIGURE-EIGHT guide. The FIGURE-EIGHT guide may be configured to place the fiber/conduit in a FIGURE-EIGHT pattern on the ground near an installation point. For instance, from the example above, the twenty-mile length of fiber may come in a roll. The apparatus may be used to stage the fiber in a FIGURE-EIGHT pattern near the first manhole rather than leave the fiber on the roll. Similarly, the apparatus may stage the eighteen miles of fiber near the second manhole following the pull operation described above.

In addition, some embodiments may include a mower. The mower can remove or trim environmental vegetation. After the environmental vegetation is trimmed, the fiber/conduit can be staged on the ground that is substantially free of environmental vegetation that may obscure or hide the fiber/conduit. These and other embodiments are described with reference to the appended figures in which similar item numbers indicate similar structures unless otherwise specified.

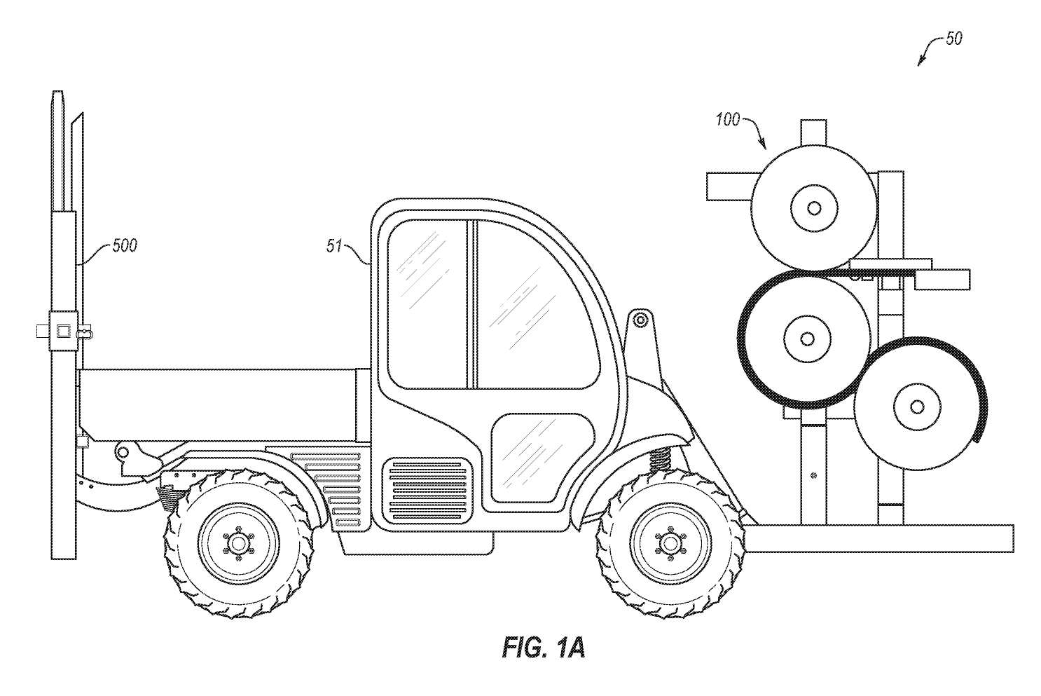

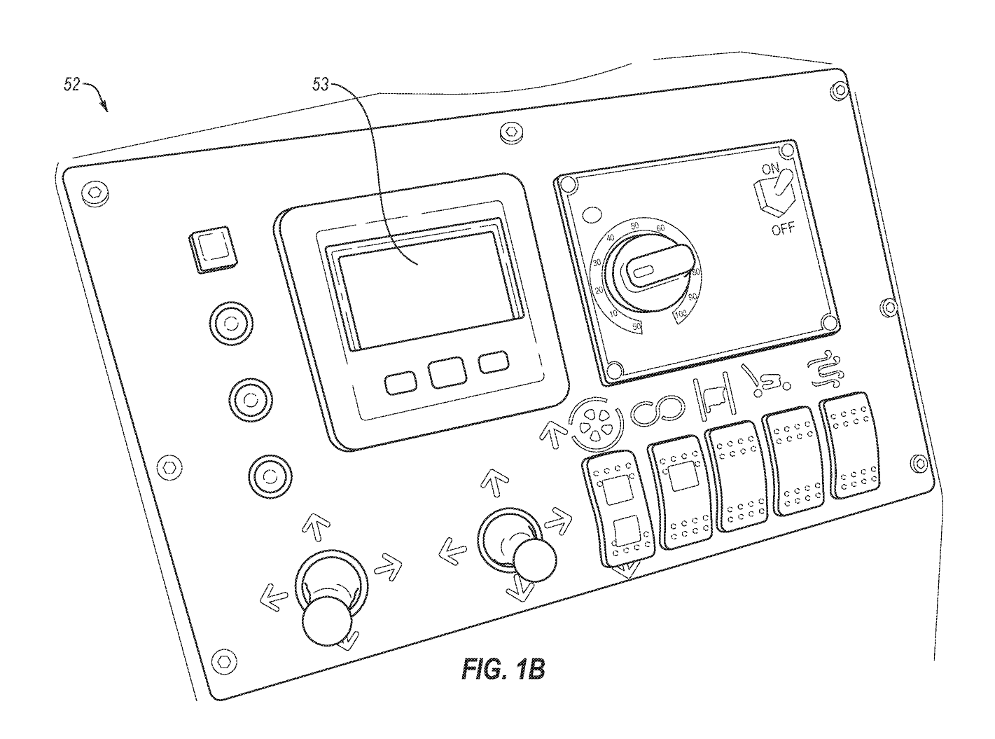

FIGS. 1A and 1B illustrate an example fiber and conduit installation machine 50 (hereinafter, “machine”). FIG. 1A is an external view of the machine 50. FIG. 1B is a view of a portion of an interior of the machine 50. For example, FIG. 1A depicts a side view of the machine 50. The machine 50 is configured for fiber/conduit installation and staging processes. The machine 50 may include an optical fiber installation and staging apparatus (hereinafter, “apparatus”) 100 and a rear structure 500 generally opposite the apparatus 100 on the machine 50.

The rear structure 500 may be configured to route fiber/conduit and support the fiber/conduit as it is moved around corners, as the fiber/conduit is rolled onto or from a spool, combinations thereof, and in other circumstances. The rear structure 500 is included as the rear part of the machine 50. Additional details of the rear structure 500 are provided herein. Additional details of the apparatus 100 are provided herein.

Between the rear structure 500 and the apparatus 100, the machine 50 includes a support vehicle 51. The support vehicle 51 is attached to the apparatus 100 and the rear structure 500. The support vehicle 51 includes a cab in which a user may operate the apparatus 100 and drive the support vehicle 51. The support vehicle 51 can be driven from one site to another or from one location to another, which may enable portability of the machine 50.

The support vehicle 51 also includes a bed. The bed may be configured for placement of equipment and accessories, which may be used in one or more fiber or conduit installation processes. In some embodiments, the support vehicle 51 is a BOBCAT® brand 4×4 industrial machine that is adapted with the rear structure 500 and the apparatus 100. In other embodiments, the support vehicle 51 may have another configuration such as a tractor, a cart, a truck, a car, and the like.

Referring to FIG. 1B, the machine 50 may further include a controller computer 52. The controller computer 52 may include a display screen 53 on which a function may be selected along with multiple control levers that control operations of the machine 50. For example, the control levers may be configured to control or route hydraulic fluid throughout the apparatus 100 to perform the functions described in the present disclosure.

The controller computer 52 may be configured to perform operations described herein. Generally, an operator inputs a function through a user interface. The controller computer 52 may then change positions of electro-hydraulic systems (valves, motors, etc.) of the apparatus 100 to execute the function.

The machine 50 may be configured to perform multiple functions related to the installation and the staging of the fiber/conduit (also called piping) in which fiber and/or conduit are installed. The functions performed by the machine 50 may include a drive function, a manhole drive function, a corner drive function, a pneumatic drive function, a FIGURE-EIGHT staging function, a spooling function, a rate adjustment function, a mowing function, or combinations thereof.

The drive function includes an advancement in a direction of the fiber and/or the conduit. For instance, the drive function may pull or push the fiber and/or the conduit along a distance. The manhole drive function may pull the fiber and/or the conduit up a first pipe of a manhole and push it down a second pipe of the manhole. The corner drive function may pull fiber and/or conduit around a corner such as a 90-degree corner. The pneumatic drive function may push the fiber and/or the conduit using pneumatic pressure. The FIGURE-EIGHT function may stage the fiber and/or the conduit in a FIGURE-EIGHT pattern. The spooling function may roll the fiber and/or the conduit onto a spool. The rate adjustment function may adjust a feed rate automatically, and the mowing function may mow or cut vegetation from around a site in which the machine 50 is used.

Throughout this application, reference is made to fiber and/or conduit. Such reference is used to indicate that the process may involve a fiber cable, multiple fiber cables (e.g., one, two, or three fiber cables), a conduit (e.g., a polyethylene conduit used in fiber cable applications), multiple conduits, or combinations thereof.

### Optical Fiber Installation and Staging Apparatus

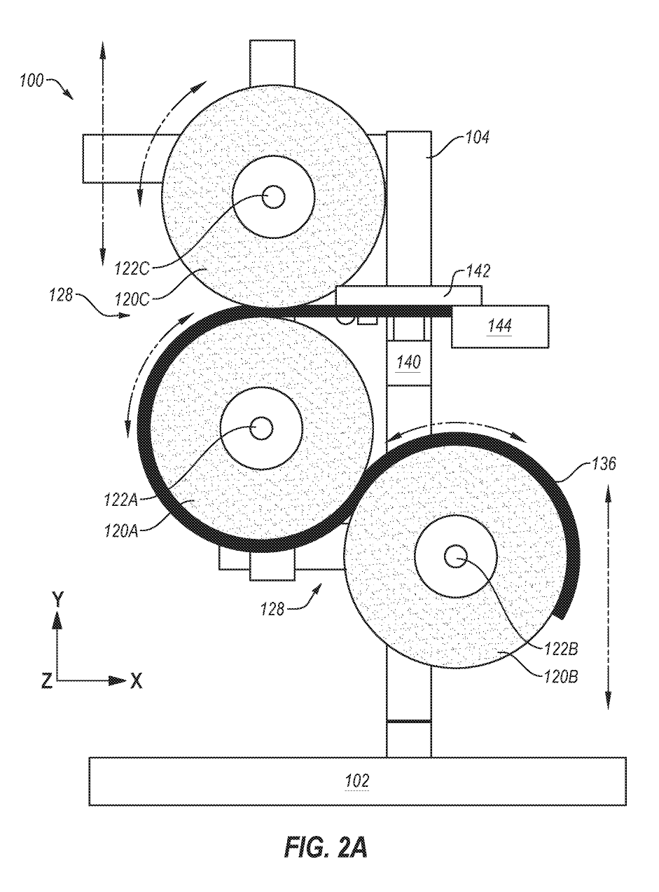

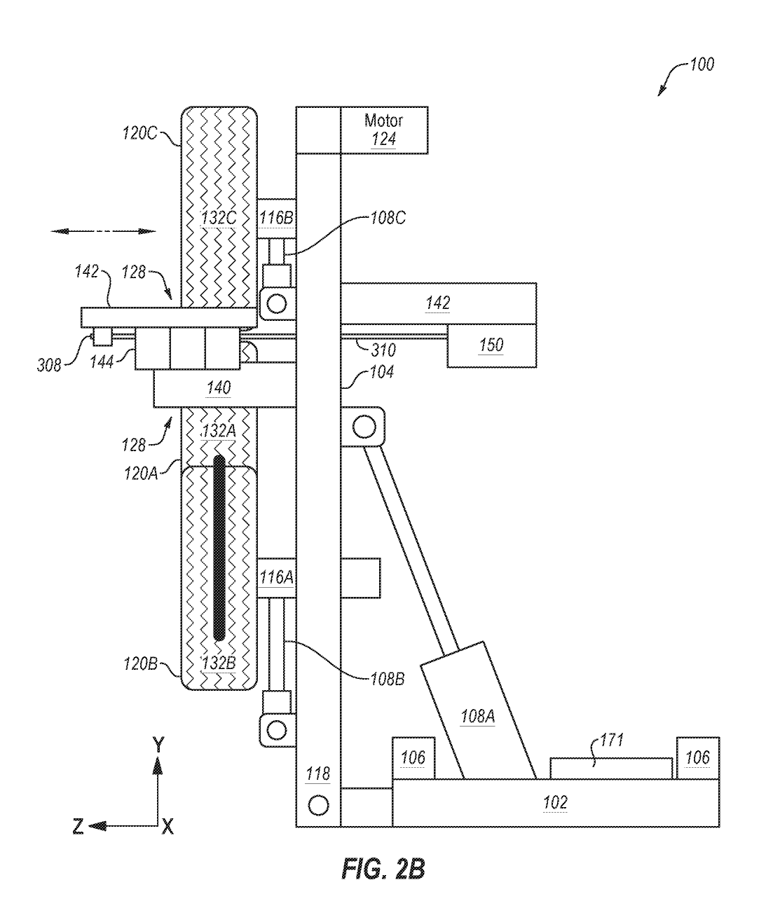

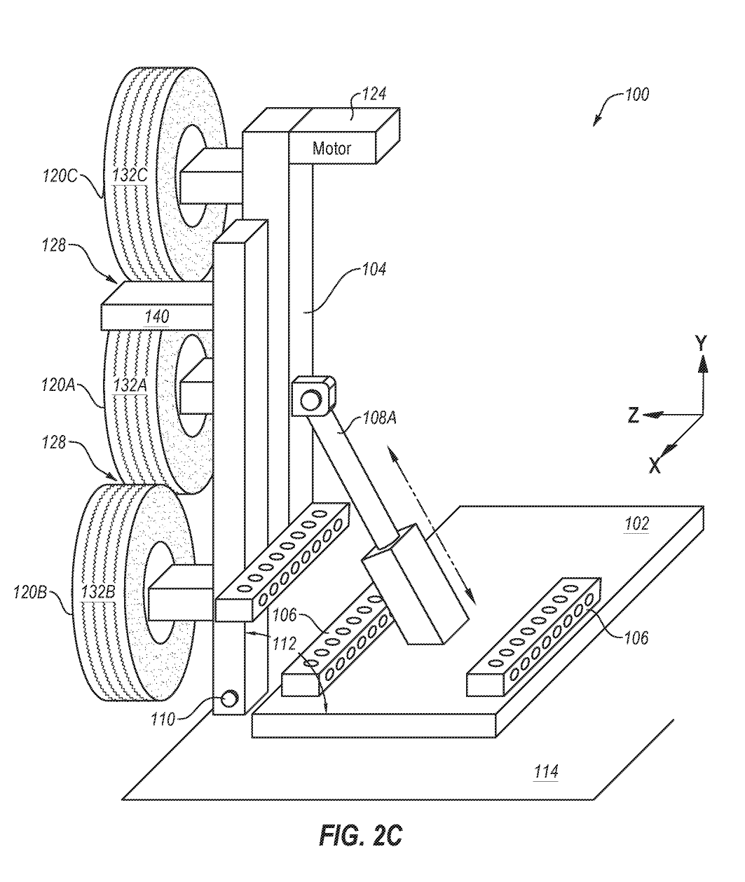

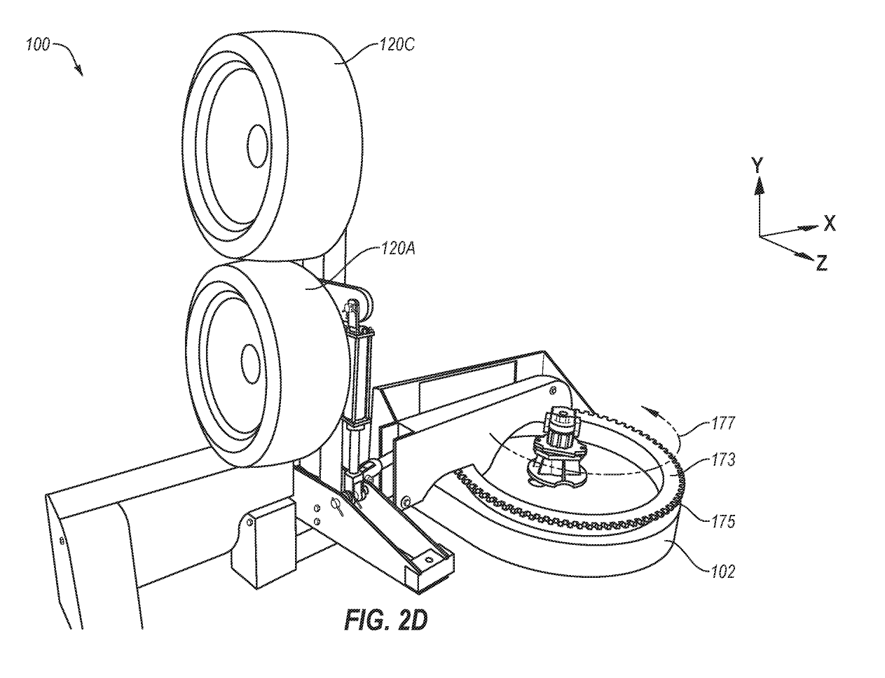

FIGS. 2A-2C illustrate block diagrams of an example apparatus 100. The apparatus 100 may be implemented for installation of optical fiber and/or conduit and for staging the optical fiber and the conduit during and prior to installation of the fiber and/or the conduit. Installation of the fiber and/or the conduit generally includes the placement of the fiber and/or the conduit underground. For instance, prior to development of the apparatus 100, a fiber installation process included digging or drilling a hole. The fiber was placed in the hole and covered up.

The apparatus 100 performs the installation process as well as several sub-processes associated with installation of the fiber and/or conduit. The apparatus 100 is generally implemented for outdoor installations that may include installations over long distances (e.g., tens to hundreds of miles or kilometers). For example, the apparatus 100 may be implemented to install fiber and conduit between two urban areas, along freeways, in new developments, in residential areas, and the like.

The apparatus 100 may include a base 102. The base 102 provides a structure to which a support structure 104, one or more manifolds 106, one or more hydraulic cylinders 108 or some combination thereof are mounted. In FIGS. 2A-2C, some of the hydraulic and pneumatic tubing that connects the manifolds 106, the hydraulic cylinders 108, etc. are omitted. The base 102 may be positionable relative to a hole or a trench into which the fiber and/or the conduit is installed. For example, the base 102 may be positioned adjacent to the hole or the trench such that the fiber and/or the conduit can run from the support structure 104 or some portion thereof directly to the hole or trench without a bend or an angle.

In the apparatus 100 of FIGS. 2A-2C, the base 102 is mechanically coupled to the support structure 104. In particular, the base 102 of the apparatus 100 is rotationally coupled to the support structure 104. The support structure 104 may accordingly rotate relative to base 102 about a pivot connection 110. The support structure 104 may be positioned at an angle 112 relative to the base 102. The angle 112 may be set such that the support structure 104 is substantially perpendicular to a surface 114 (FIG. 2C) on which the apparatus 100 is positioned. For example, the angle 112 may be set such that the support structure 104 is perpendicular to the base 102 and/or the surface 114. Alternatively, the angle 112 may be set such that the angle 112 is greater than ninety degrees or less than ninety degrees.

The embodiment of FIGS. 2A-2C may include a leveling subsystem. The leveling subsystem is configured to control the angle 112 and to control the position of the support structure 104 relative to the surface 114. The leveling subsystem may be an electro-hydraulic system that includes one or more valves, actuators, rams, cylinders, pumps, etc. that may be electrically controlled.

For instance, in the embodiment of FIGS. 2A-2C, the leveling system may include a first hydraulic cylinder 108A. The first hydraulic cylinder 108A is fixed to the base 102 and to the support structure 104. A length of the first hydraulic cylinder 108A may increase and decrease, which may change or set the angle 112 between the base 102 and the support structure 104. For example, an increase in the length of the first hydraulic cylinder 108A increases the angle 112. A decrease in the length of the first hydraulic cylinder 108A may decrease the angle 112. The first hydraulic cylinder 108A may be controlled by porting hydraulic fluid to the first hydraulic cylinder 108A using an electrically actuated solenoid valve in some embodiments. In other embodiments, the length of the first hydraulic cylinder 108A may be controlled through other pneumatic or mechanical systems. The controller computer 52 of FIG. 1B may include a control that changes the position of the base 102 relative to the support structure 104.

In the embodiment of FIGS. 2A-2C, there is one first hydraulic cylinder 108A that affects or controls the angle 112. In other embodiments, more than one hydraulic cylinder may control the angle 112. Additionally or alternatively, in some embodiments, another system may be implemented to control the angle 112. In some embodiments, the leveling system may include a level that is fixed to support structure 104. The level may be configured to indicate when the support structure 104 is substantially perpendicular to the surface.

Referring to FIG. 2D, another example embodiment of the apparatus 100 is depicted. The apparatus 100 of FIG. 2D includes the base 102 on which a turntable 173 is positioned. The turntable 173 includes a rotational gear 175 that enables a positioning of at least some of the remaining components (e.g., cylindrical structures 120A and 120C described below) of the apparatus 100 relative to a support vehicle such as the support vehicle 51 of FIG. 1A. For example, the turntable 173 may enable the remaining portions of the apparatus 100 to rotate about an axis in a central portion of the rotational gear 175 (parallel to the y-axis of FIG. 2D), which may rotationally position the remaining portions. The rotation is represented in FIG. 2D by arrow 177. The turntable 173 may be hydraulically operated. For instance, the turntable 173 may be driven by a hydraulic motor in some embodiments.

In some embodiments, a lower support structure may be included in the turntable 173. For instance, a floating wheel may be positioned near an outer edge of the turntable 173, which may maintain or help maintain the turntable 173 above the ground or a surface on which the apparatus is operated.

Referring to FIGS. 2A-2D, the apparatus 100 includes one or more cylindrical structures 120A, 120B, and 120C (generally, cylindrical structure 120 or cylindrical structures 120). In some embodiments, one or more of the cylindrical structures 120 may include an automotive wheel and tire combination. In other embodiments, the cylindrical structures 120 may include a pulley or another cylindrical structure. With reference to FIG. 2A, the cylindrical structures 120 are configured to rotate about axels 122A-122C and relative to the support structure 104. For example, the axels 122A-122C are fixed or releasably fixed to the support structure 104. The axels 122A-122C enables rotation of the cylindrical structures 120 relative to the support structure 104. In the embodiment of FIG. 2A, the axels 122A-122C may be substantially parallel to one another and to the z-axis in an arbitrarily defined coordinate system.

Referring back to FIGS. 2A-2C, the support structure 104 includes a fixed portion and one or more movable portions. The fixed portion includes one or more sections of the support structure 104 that do not translate relative to one another. These sections are welded or otherwise coupled (e.g., fastened, adhered, or integrally formed) relative to one another in a permanently or substantially permanently manner. The support structure 104 also includes one or more movable portions. The movable portions are coupled to the fixed portion, but are configured to move relative to the fixed portions. For example, with reference to FIG. 2B, the support structure 104 includes a first movable portion 116A and a second movable portion 116B. The movable portions 116A and 116B are omitted from FIGS. 2A, 2C, and 2D. The first movable portion 116A and the second movable portion 116B are coupled to a fixed portion 118 of the support structure 104.

In some embodiments, a first axel 122A of the first cylindrical structure 120A may be coupled to fixed portion 118. Accordingly, the first cylindrical structure 120A may be configured to rotate relative to the support structure 104, but may not translate relative to the support structure 104. In these and other embodiments, a second axel 122B of the second cylindrical structure 120B may be coupled to the first movable portion 116A. Accordingly, the second cylindrical structure 120B may be configured to rotate relative to the support structure 104 and to translate relative to the fixed portion 118 of the support structure 104. In particular, the second cylindrical structure 120B may translate in substantially the y-direction. Translation of the second cylindrical structure 120B in the y-direction may decrease or increase a distance between the first cylindrical structure 120A and the second cylindrical structure 120B. In other embodiments, the first cylindrical structure 120A may be configured to translate and the second cylindrical structure 120B may not translate.

In the embodiment of FIG. 2B, a second hydraulic cylinder 108B may be configured to translate the second cylindrical structure 120B and/or the first movable portion 116A relative to the support structure 104. The second hydraulic cylinder 108B may be electro-hydraulically controlled. For instance, one or more solenoid-actuated valves may control the port of hydraulic fluid to the second hydraulic cylinder 108B, which may increase or decrease a length of the second hydraulic cylinder 108B and translate the first movable portion 116A relative to the fixed portion 118.

In some embodiments, the second cylindrical structure 120B (or another of the cylindrical structures 120) may be omitted or may be removable. For instance, the embodiment of FIG. 2D only includes two cylindrical structures. The second cylindrical structure 120B may be selected for one or more functionalities described in the present disclosure.

A third axel 122C of the third cylindrical structure 120C may be coupled to the second movable portion 116B. Accordingly, the third cylindrical structure 120C may be configured to rotate relative to the support structure 104 and to translate relative to the fixed portion 118 of the support structure 104. In particular, the third cylindrical structure 120C can translate in substantially the y-direction. Translation of the third cylindrical structure 120C in the y-direction may decrease or increase a distance between the first cylindrical structure 120A and the third cylindrical structure 120C.

In the embodiment of FIG. 2B, a third hydraulic cylinder 108C may be configured to translate the third cylindrical structure 120C and/or the second movable portion 116B relative to the support structure 104. Similar to the second hydraulic cylinder 108B, the third hydraulic cylinder 108C may be electro-hydraulically controlled. For instance, one or more solenoid actuated valves may control the port of hydraulic fluid to the third hydraulic cylinder 108C, which may increase or decrease a length of the third hydraulic cylinder 108C and translate the second movable portion 116B and/or the third cylindrical structure 120C relative to the fixed portion 118.

In the embodiment of FIGS. 2A-2C, the apparatus 100 may include a motor 124. The motor 124 is mechanically coupled to the support structure 104. In other embodiments, the motor 124 may be mechanically coupled to the base 102 or positioned in a support vehicle. The motor 124 may be configured to drive the third cylindrical structure 120C. The motor 124 causes rotation or directly rotates the third cylindrical structure 120C relative to the support structure 104.

The motor 124 may also indirectly cause the rotation of the first cylindrical structure 120A and the second cylindrical structure 120B. For instance, the third cylindrical structure 120C can be translated towards the first cylindrical structure 120A (e.g., in the negative y-direction). Contact between the third cylindrical structure 120C and the first cylindrical structure 120A transfers driven rotation of the third cylindrical structure 120C to the first cylindrical structure 120A and causes rotation of the first cylindrical structure 120A. The second cylindrical structure 120B can be translated towards the first cylindrical structure 120A (e.g., in the positive y-direction). Contact between the second cylindrical structure 120B and the first cylindrical structure 120A with the third cylindrical structure 120C in contact with the first cylindrical structure 120A transfers driven rotation of the third cylindrical structure 120C to the second cylindrical structure 120B via the first cylindrical structure 120A and causes rotation of the first cylindrical structure 120A and the second cylindrical structure 120B.

Between the cylindrical structures 120 is an interface 128. The interface 128 may be created between one or more portions of circumferential surfaces 132A-132C of the cylindrical structures 120. For example, in embodiments in which the cylindrical structures 120 include tires, the interface 128 may include portions of the tread between the cylindrical structures 120. In the embodiment of FIGS. 2A-2C, the interface 128 may include a portion of a first circumferential surface 132C of the third cylindrical structure 120C and a portion of a first circumferential surface 132A of the first cylindrical structure 120A. The interface 128 may also include a portion of the first circumferential surface 132A and a portion of a second circumferential surface 132B of the second cylindrical structure 120B.

With reference to FIG. 2A, a fiber or a conduit (fiber/conduit) 136 may be introduced in the interface 128 or portions thereof. The third cylindrical structure 120C can be translated towards the first cylindrical structure 120A, which pinches the fiber/conduit 136 between the third cylindrical structure 120C and the first cylindrical structure 120A. The contact between the fiber/conduit 136 transfers the driven rotation of the third cylindrical structure 120C to the first cylindrical structure 120A and causes rotation of the first cylindrical structure 120A. In addition, the contact between the fiber/conduit 136 mechanically advances the fiber/conduit 136 through the interface 128. For instance, when the third cylindrical structure 120C rotates in the clockwise direction, the fiber/conduit 136 may be mechanically advanced in the negative x-direction. When the third cylindrical structure 120C rotates in the counter-clockwise direction, the fiber/conduit 136 may be mechanically advanced in the x-direction.

Similarly, the fiber/conduit 136 may be introduced between the second cylindrical structure 120B and the first cylindrical structure 120A. The second cylindrical structure 120B can be translated towards the first cylindrical structure 120A and pinch the fiber/conduit 136 between the second cylindrical structure 120B and the first cylindrical structure 120A. Contact between the second cylindrical structure 120B, the first cylindrical structure 120A, and the fiber/conduit 136 transfers the driven rotation of the third cylindrical structure 120C to the second cylindrical structure 120B via the first cylindrical structure 120A and the fiber/conduit 136. The contact causes rotation of the first cylindrical structure 120A and the second cylindrical structure 120B and mechanically advances the fiber/conduit 136 in the interface 128.

In the embodiment of FIGS. 2A-2C, the third cylindrical structure 120C is driven, the third and the second cylindrical structures 120C and 120B translate, and the first cylindrical structure 120A is fixed. In other embodiments, the cylindrical structures 120 may be arranged in any combination to support mechanical advancement of the fiber/conduit 136. For instance, the second cylindrical structure 120B may be driven and the first and third cylindrical structures 120A and 120C may translate.

Referring to FIGS. 2A and 2B, the apparatus 100 may include a guidance arm 140. The guidance arm 140 is mechanically coupled to the fixed portion 118 of the support structure 104. A guidance structure 142 is positioned on the guidance arm 140. The guidance arm 140 may align the guidance structure 142 relative to the cylindrical structures 120. For example, in the embodiment of FIGS. 2A and 2B, the guidance arm 140 may align the guidance structure 142 with the interface 128 or a boundary between the third cylindrical structure 120C and the first cylindrical structure 120A.

The guidance structure 142 may define one or more receivers 144 that may be configured to receive one or more tools that may be implemented to install or to stage the fiber/conduit 136. A first tool includes a pneumatic installer that is used for installation of the fiber/conduit 136.

### Rear Structure

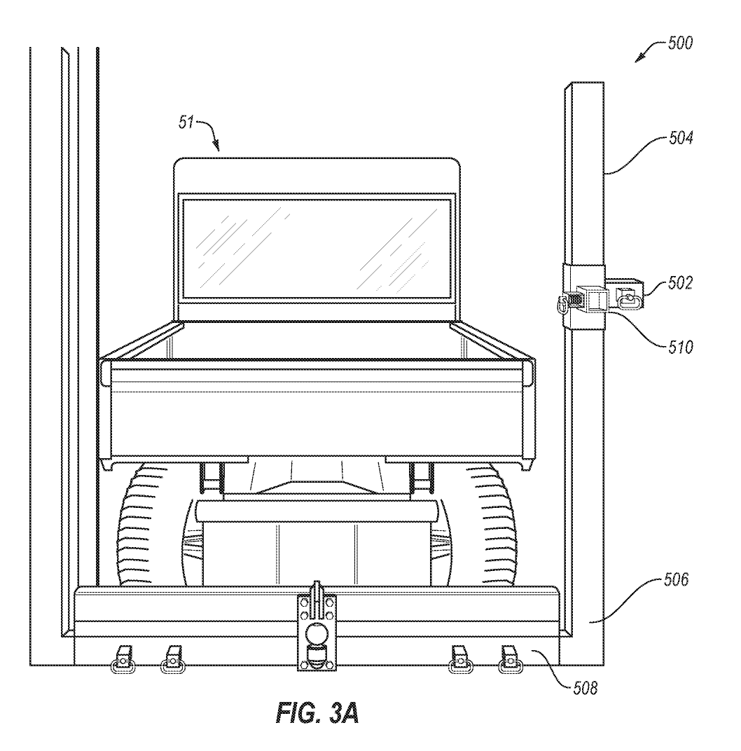

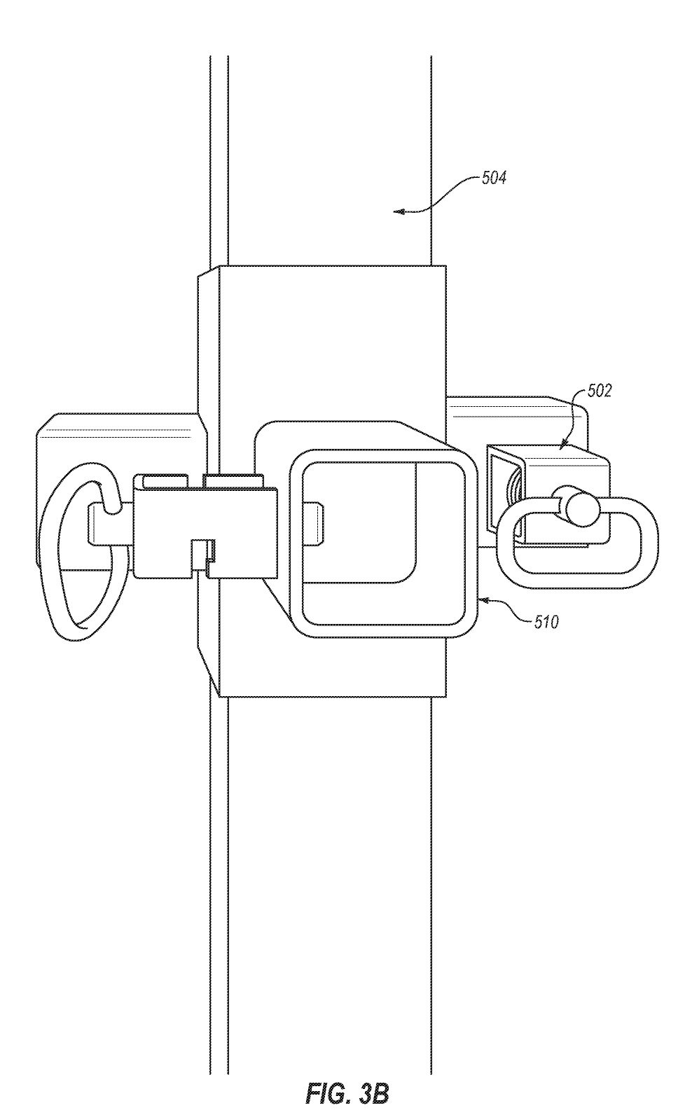

FIGS. 3A and 3B depict the rear structure 500. In FIG. 3A, the rear structure 500 is depicted with the support vehicle 51. FIG. 3B is a portion of the rear structure 500 that includes a coupling structure 502. The rear structure 500 includes a horizontal element 506 and one or more vertical elements 504. In the depicted embodiment, the vertical elements 504 are box beams that may be positioned at various distances from the horizontal element 506. For instance, the vertical elements 504 may include a normal portion 508 that extends into the horizontal element 506. Withdrawal from or positioning within the horizontal element 506 of the normal portion 508 enables the positioning of the vertical element 504 two or more particular distances from the horizontal element 506.

With reference to FIGS. 3A and 3B, the coupling structure 502 may be positioned along the vertical element 504. For example, the coupling structure 502 may be moved vertically (up and down) and secured to at one or more heights on the vertical element 504.

The coupling structure 502 may include multiple couplers 510. The couplers 510 may be fit with components that are used to stage and support the fiber and/or the conduit. The couplers 510 may generally extend normally (e.g., at about 90 degree angles) from the vertical element 504. The components may be secured in the couplers 510 using the pull-ring assemblies that may interface with an opening defined in the components. The couplers 510 may be interfaced with multiple types of components such as D-rings, which may support fiber/conduit as it is pulled (as described elsewhere in the present disclosure).

### Drive Function

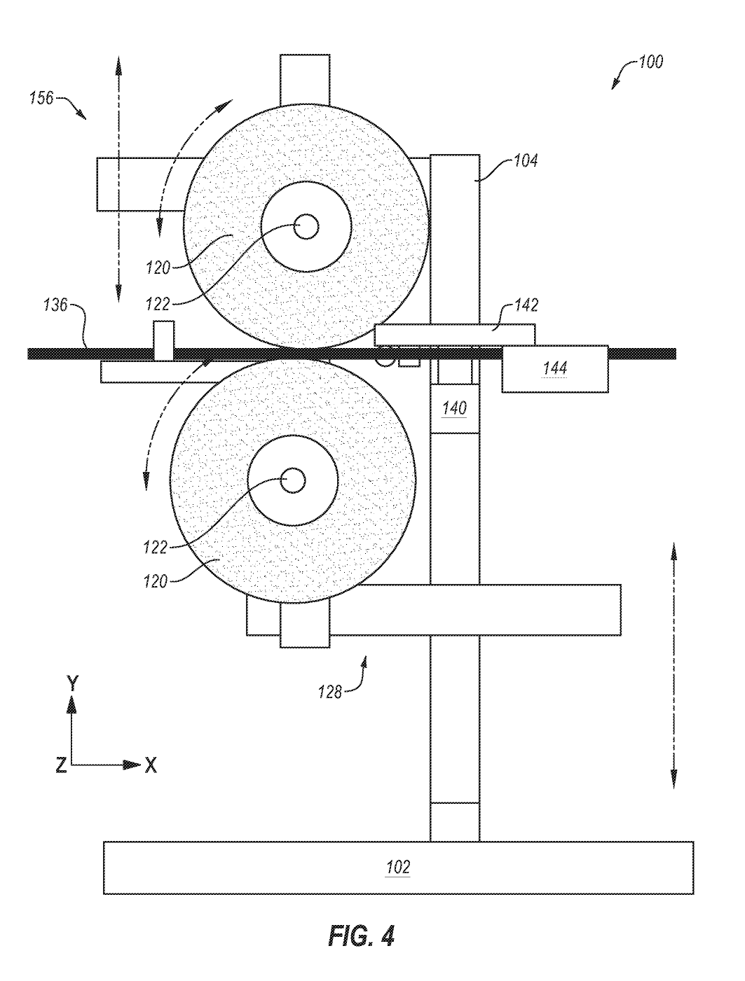

FIG. 4 is a block diagram that depicts a portion of the apparatus 100 configured to drive (e.g., pull) the fiber/conduit 136. In FIG. 4, the apparatus 100 is depicted with the fiber/conduit 136. Generally, the fiber/conduit 136 is being driven in the positive x-direction of FIG. 4. In the configuration of FIG. 4, the cylindrical structures 120 are translated relative to one another to contact the fiber/conduit 136 therebetween and to contact one another. One of the cylindrical structures 120 (in the depicted embodiment, the top cylindrical structure) is rotated. In response, the fiber/conduit 136 is driven. The fiber/conduit 136 may be driven out the guidance structure 142.

The cylindrical structures 120 may be translated relative to one another such that the fiber/conduit 136 can be placed between the cylindrical structures. The conduit may be routed through a support structure that may separate multiple conduits as they are fed between the cylindrical structures 120.

For example, the uppermost cylindrical structure 120 being translated towards the other cylindrical structure 120 and may contact the other cylindrical structure 120. The fiber/conduit 136 may be positioned between the cylindrical structures 120 such that rotation of the uppermost cylindrical structure 120 rotates the other cylindrical structure and drives the fiber/conduit 136. While the fiber/conduit 136 is used in the singular, the apparatus may drive more than one of the fiber/conduit 136. For instance, the apparatus 100 may be configured to drive two, three, four, or more fibers/conduits 136.

The drive function may be used in one or more of the functions described below. Additionally, the drive function may be used to move the fiber/conduit 136 from one spot to another. The rate at which the fiber/conduit 136 may be driven may be substantially greater than other means (e.g., pulling by hand). For example, the drive function may move the fiber/conduit 136 several hundred feet per minute (e.g., between about 500 feet per minute and 675 feet per second.)

### Manhole Drive Function

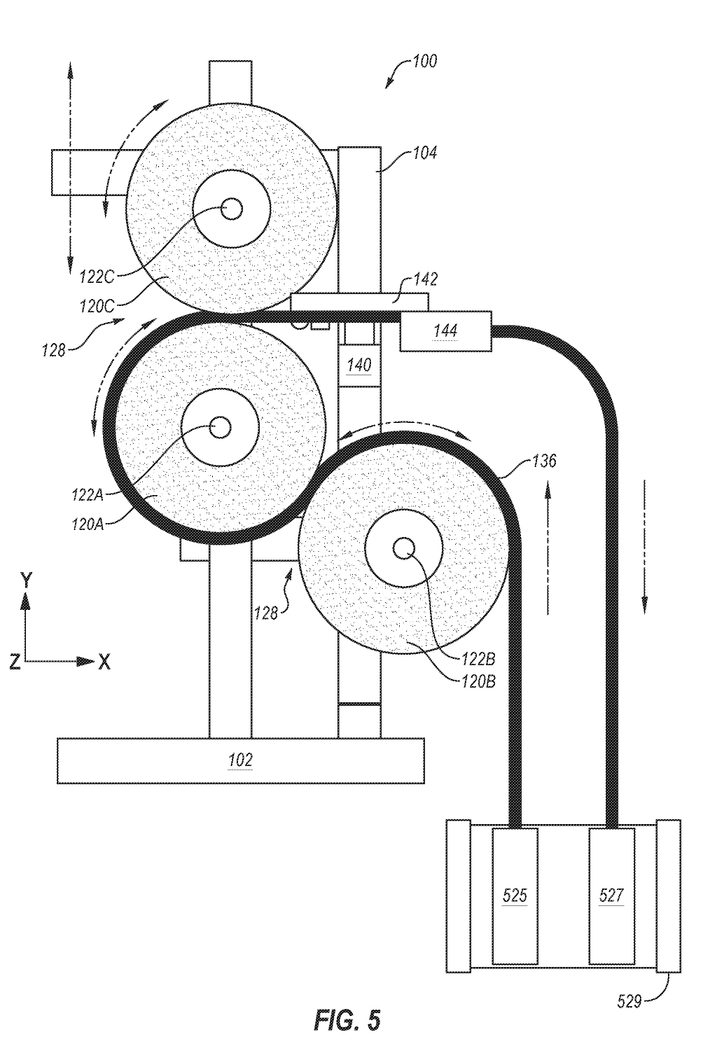

FIG. 5 is a block diagram that depicts a portion of the apparatus 100 configured for a manhole drive function. The manhole drive function may include pulling the fiber/conduit 136 up and out of a first pipe 525 or another suitable source and then drive the fiber/conduit 136 into a second pipe 527 or another suitable destination. The machine 50 may be positioned such that the apparatus 100 is near or adjacent to a manhole 529. The first pipe 525 and the second pipe 527 may be positioned at least partially in the manhole 529 and configured to receive and have installed therein the fiber/conduit 136. The apparatus 100 may be further positioned (e.g., using the controller computer) such that this first pipe 525 is aligned with the second cylindrical structure 120B. As depicted in FIG. 5, the fiber/conduit 136 may be routed up and over the second cylindrical structure 120B, between the second cylindrical structure 120B and the first cylindrical structure 120A, then between the first cylindrical structure 120A and the third cylindrical structure 120C. The fiber/conduit 136 may then be routed out the guidance structure 142 and down into the second pipe 527. Following the routing of the fiber/conduit 136, the cylindrical structures 120 may be translated relative to one another such that the cylindrical structures 120 contact another of the cylindrical structures 120 and the fiber/conduit 136. Rotation of the third (uppermost) cylindrical structure 120C may rotate the first cylindrical structure 120A via contact and the second cylindrical structure 120B via the first cylindrical structure 120A. The rotation may thus pull the fiber/conduit 136 up and out of the first pipe 525 and then push the fiber/conduit 136 down and into the second pipe 527.

The manhole drive function may be used any time there is the first pipe 525 and the second pipe 527 in the manhole 529. For example, the fiber/conduit 136 may be installed along a mile long portion of the road. The road may include the first pipe 525 and the second pipe 527 buried alongside the road. The first pipe 525 may be the first section and the second pipe 527 may be a second section. The manhole 529 may enable access to the two sections. To install the fiber/conduit 136 in the first pipe 525 and the second pipe 527, the fiber/conduit 136 may be pushed to the manhole 529 (e.g., via the drive function). The machine 50 may then move to the manhole 529 and a remaining portion of the fiber/conduit 136 may be pulled via the manhole drive function and pushed into the second pipe 527.

### Corner Drive Function

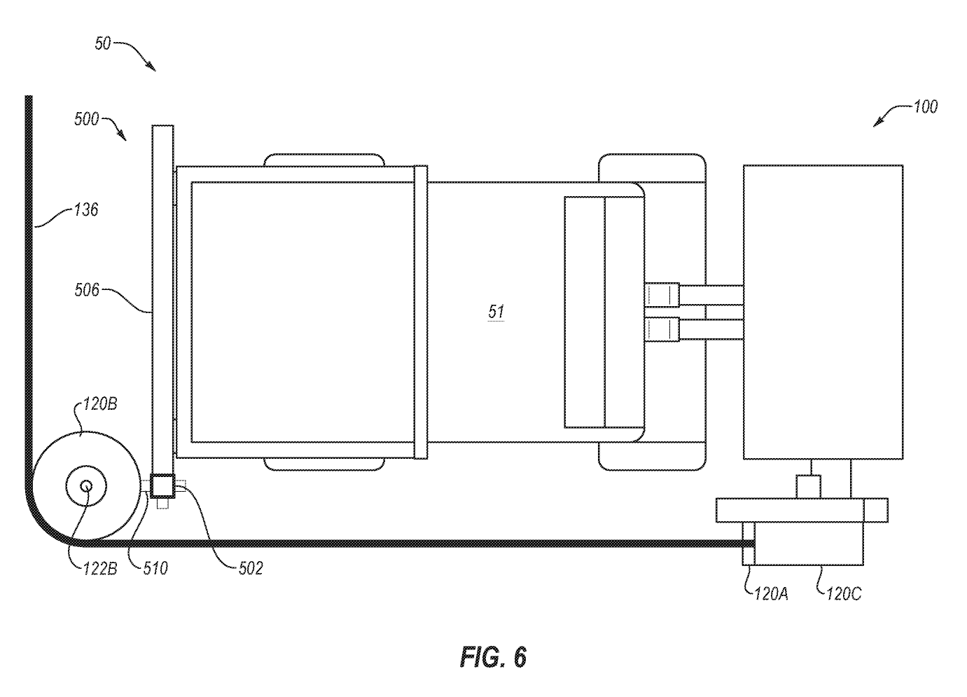

FIG. 6 is a block diagram of the machine 50 configured from the corner drive function. FIG. 6 depicts the machine 50 from the top. The apparatus 100 at the front of the support vehicle 51 is configured as shown in FIG. 4 to perform the drive function.

The second cylindrical structure 120B may be fitted to the couplers 510 of the rear structure 500. For example, the second cylindrical structure 120B may be removed from the apparatus 100 and placed on the coupling structure 502 such that it extends from the support vehicle 51. In this configuration, the second cylindrical structure 120B may be oriented 90 degrees or perpendicular to the first and third cylindrical structures 120A and 120C. The fiber/conduit 136 may then be routed around at least a portion of the second cylindrical structure 120B then to the apparatus 100. The third cylindrical structure 120C may then rotate to drive the fiber/conduit 136. As the fiber/conduit 136 is driven, the second cylindrical structure 120B rotates about the second axle 122B. The second cylindrical structure 120B holds the fiber/conduit 136 taught and prevents the fiber/conduit 136 from becoming kinked or bent to an angle that would damage the fiber/conduit 136.

### Pneumatic Drive Function

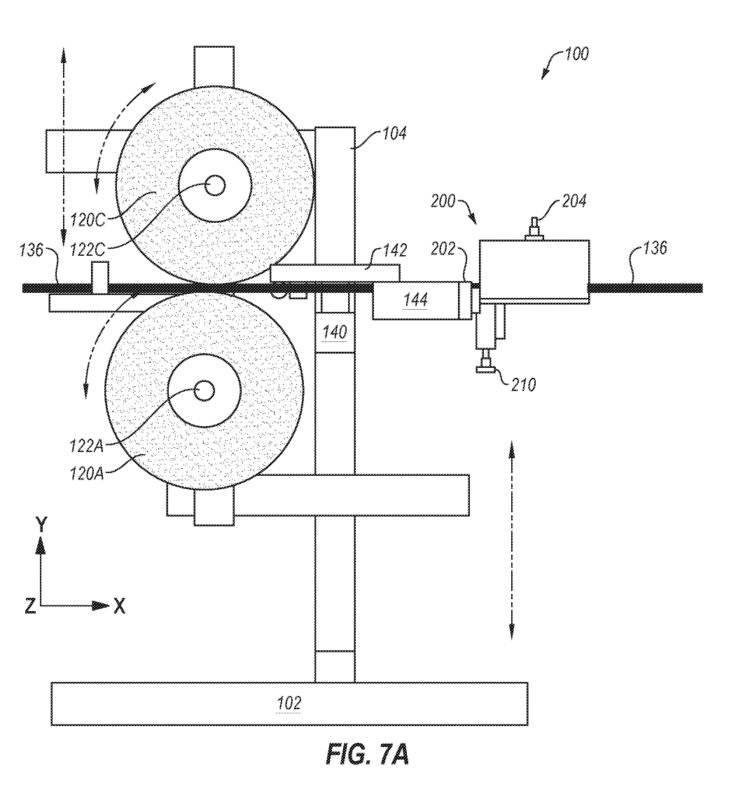

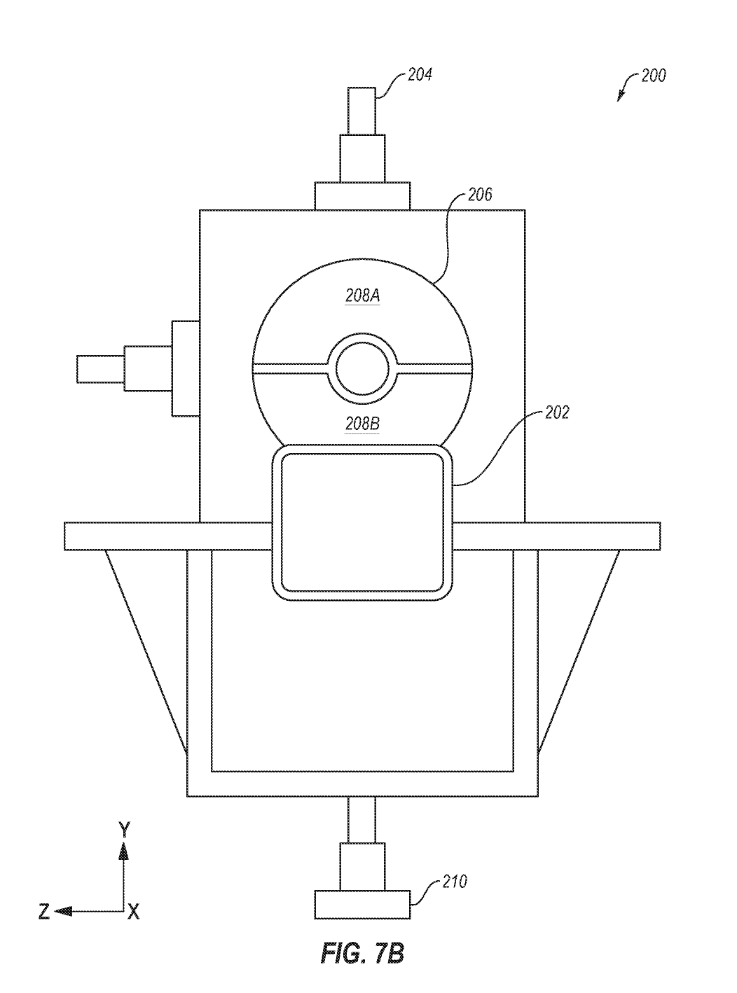

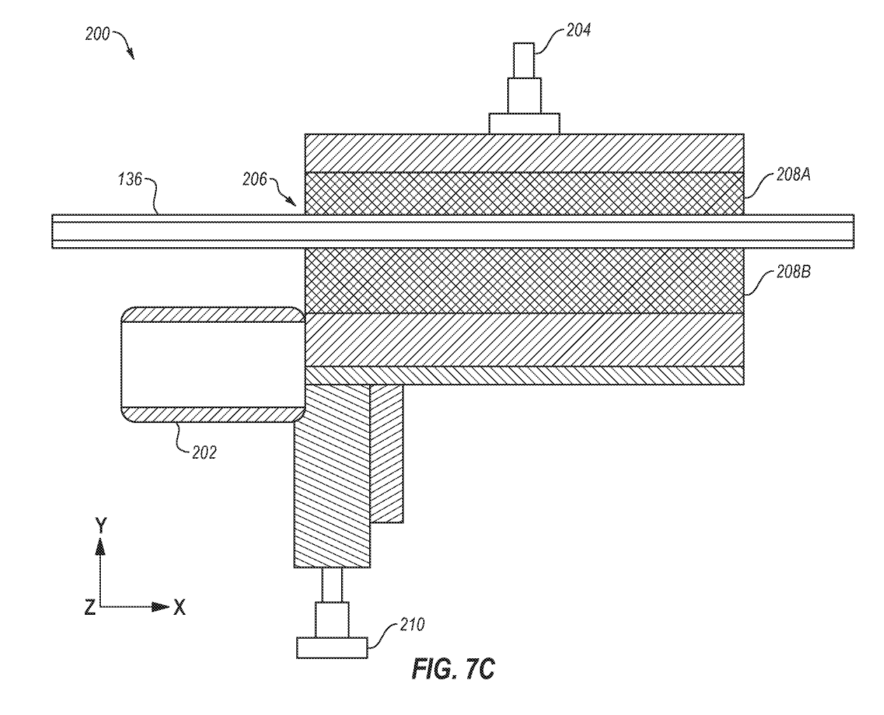

FIG. 7A is a block diagram that depicts the apparatus 100 configured for a pneumatic drive function. FIGS. 7B and 7C are block diagrams of an example embodiment of a pneumatic installer 200 that may be implemented in the apparatus 100 to perform the apparatus 100. In FIG. 7A, the pneumatic installer 200 is shown installed in the apparatus 100. In FIG. 7B, an end view of the pneumatic installer 200 is shown. In FIG. 7C, a section view of the pneumatic installer 200 is shown. The pneumatic installer 200 may be configured to retain the fiber/conduit 136. In the pneumatic drive function configuration, the fiber/conduit 136 is pushed through rotation of the cylindrical structures 120 and via a pneumatic pressure applied to the pneumatic installer 200.

The pneumatic installer 200 includes an adaptor 202. The adaptor 202 is configured to be received in the receiver 144 of the guidance structure 142. For example, as shown in FIG. 7A, the adaptor 202 may be positioned in the receiver 144. Placement of the adaptor 202 in the receiver 144 may align a central volume 206 of the pneumatic installer 200 with the guidance structure 142. The fiber/conduit 136 may be routed through the central volume 206. In the central volume 206, one or more retainers 208A and 208B may clamp the fiber/conduit 136. An adjuster 210 may force a first retainer 208A against the fiber/conduit 136 and a second retainer 208B to clamp the fiber/conduit 136 therebetween.

In some embodiments, the fiber/conduit 136 is introduced to the interface 128 and then routed through the central volume of the pneumatic installer 200. A pneumatic source is attached to a pneumatic fitting 204. A pneumatic pressure is applied to the pneumatic installer 200, which pushes the fiber/conduit 136. The pneumatic pressure may blow out an end of the fiber/conduit 136 which may interrupt the soil and enable the fiber/conduit 136 to be pushed into the soil.

In addition, e.g., subsequent to the pressure pushing the fiber/conduit 136, the cylindrical structures 120 can push the fiber/conduit 136. For example, a conduit may be pushed via the pneumatic source about a mile. The conduit may then be pushed about another mile using the cylindrical structures 120. The pneumatic pressure may be about 200 pounds per square inch (PSI). Both the pneumatic pressure and the cylindrical structures 120 are not necessary. For example, in some circumstances, the pneumatic pressure may be used to push the fiber/conduit 136 without the cylindrical structures 120 or vice versa. The apparatus 100 using both the pneumatic pressure and the cylindrical structure 120 may push the fiber/conduit 136 in a range of about 1500 feet to about 2200 feet.

### Figure-Eight Function

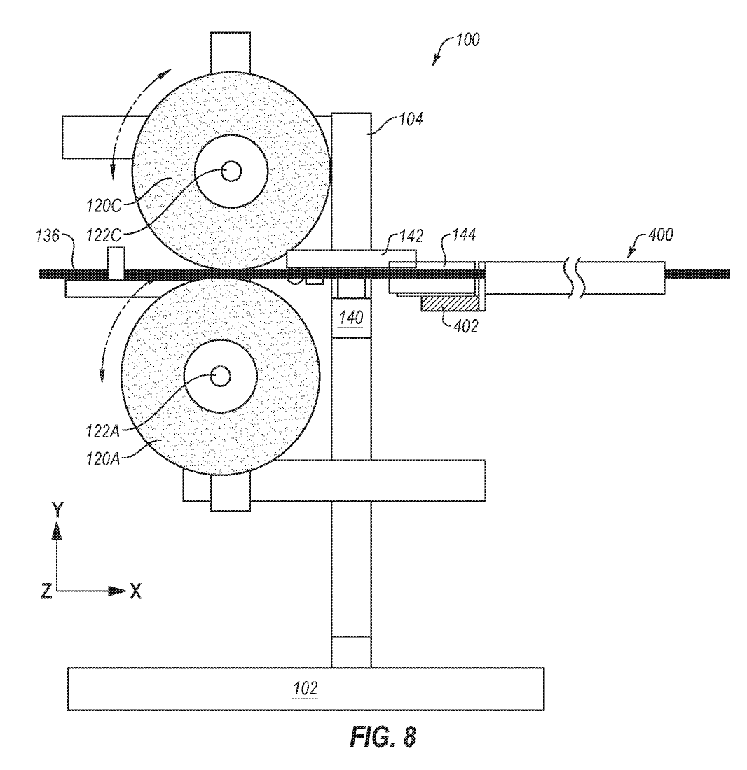

FIG. 8 is a block diagram that depicts the apparatus 100 configured for a FIGURE-EIGHT function. The FIGURE-EIGHT function may include the staging of the fiber/conduit 136. In particular, the fiber/conduit 136 cannot be bent beyond a particular angle before it is damaged. The staging of the fiber/conduit 136 in the FIGURE-EIGHT pattern enables the fiber/conduit 136 to be removed from a roll or pulled along a distance and placed on the ground adjacent to a work area. Later, the fiber/conduit 136 may be installed or rolled onto another roll, etc.

The apparatus 100 is configured to perform the FIGURE-EIGHT function and stage the fiber/conduit 136 in a FIGURE-EIGHT pattern. The FIGURE-EIGHT pattern may include a stack of connected FIGURE-EIGHTS stacked on one another. The apparatus may create FIGURE-EIGHT patterns in which each FIGURE-EIGHT has a slightly smaller length. For instance, the bottom FIGURE-EIGHT (on the ground) may be a little bit (e.g., a thickness of the fiber/conduit 136, about an inch, about half an inch, or another suitable distance) shorter than the FIGURE-EIGHT that is stacked directly on top of the bottom FIGURE-EIGHT. A length of the FIGURE-EIGHT may be controlled by the controller computer (e.g., 52). For example, as described below the FIGURE-EIGHT pattern may be created by pushing the fiber/conduit 136 as a FIGURE-EIGHT guide 400 is oscillated. The controller computer may set the rate at which the fiber/conduit 136 is driven and/or the time(s) in which the FIGURE-EIGHT guide 400 stops at ends of the oscillation. To reduce the size of the FIGURE-EIGHTS, the time in which the FIGURE-EIGHT guide 400 stops at the end of the oscillations is reduced at each oscillation. For example, the time the oscillation stops on the bottom FIGURE-EIGHT may be 1000 ms or another suitable time period. The time the oscillation stops on a next-to-bottom FIGURE-EIGHT may be about 999 ms. The time the oscillation stops on a subsequent FIGURE-EIGHT may be about 998 ms, etc. In some embodiments, the FIGURE-EIGHT patterns may range from about 8 feet in length of a bottom FIGURE-EIGHT to about 70 feet in length.

In the configuration of FIG. 8, the guidance structure 142 may be implemented and configured to oscillate relative to the guidance arm 140. In FIG. 8, the FIGURE-EIGHT guide 400 is retained in the apparatus 100. The FIGURE-EIGHT guide 400 includes an adaptor 402. The adaptor 402 is configured to be received by the receivers 144 of the guidance structure 142. The FIGURE-EIGHT guide 400 defines a volume in which the fiber/conduit 136 is positioned and through which the fiber/conduit 136 can move. Oscillation of the guidance structure 142 rotates the FIGURE-EIGHT guide 400 from the first rotational position to the second rotational position and back.

The FIGURE-EIGHT guide 400 may be used to stage the fiber/conduit 136 in a FIGURE-EIGHT pattern on the ground near the apparatus 100. For example, as the guidance structure 142 and the FIGURE-EIGHT guide 400 oscillate, the cylindrical structures 120 rotate at a particular rate. Rotation of the cylindrical structures 120 drives the fiber/conduit 136 through the volume of the FIGURE-EIGHT guide 400. The particular rate may include intermediate and/or periodic bursts that drive a particular length of the fiber/conduit 136 through the volume as the FIGURE-EIGHT guide 400 moves between the first rotational position to the second rotational position and back.

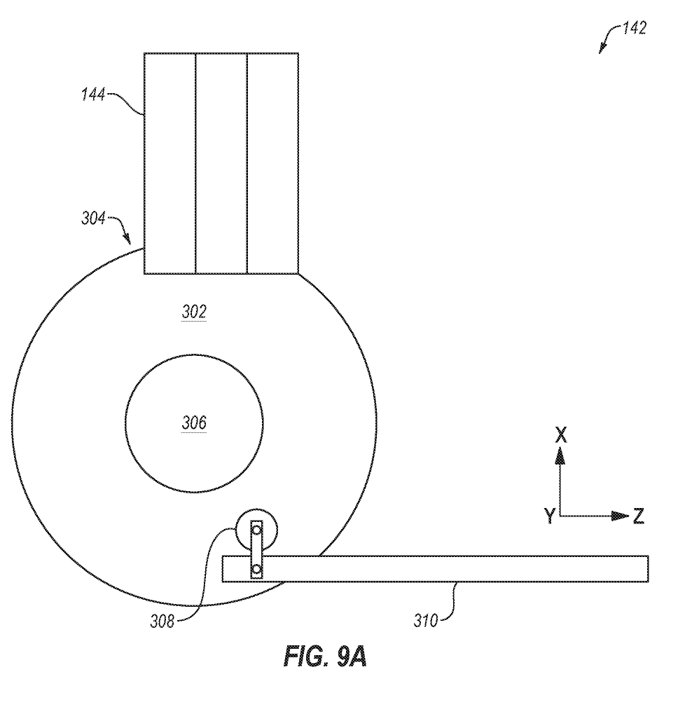

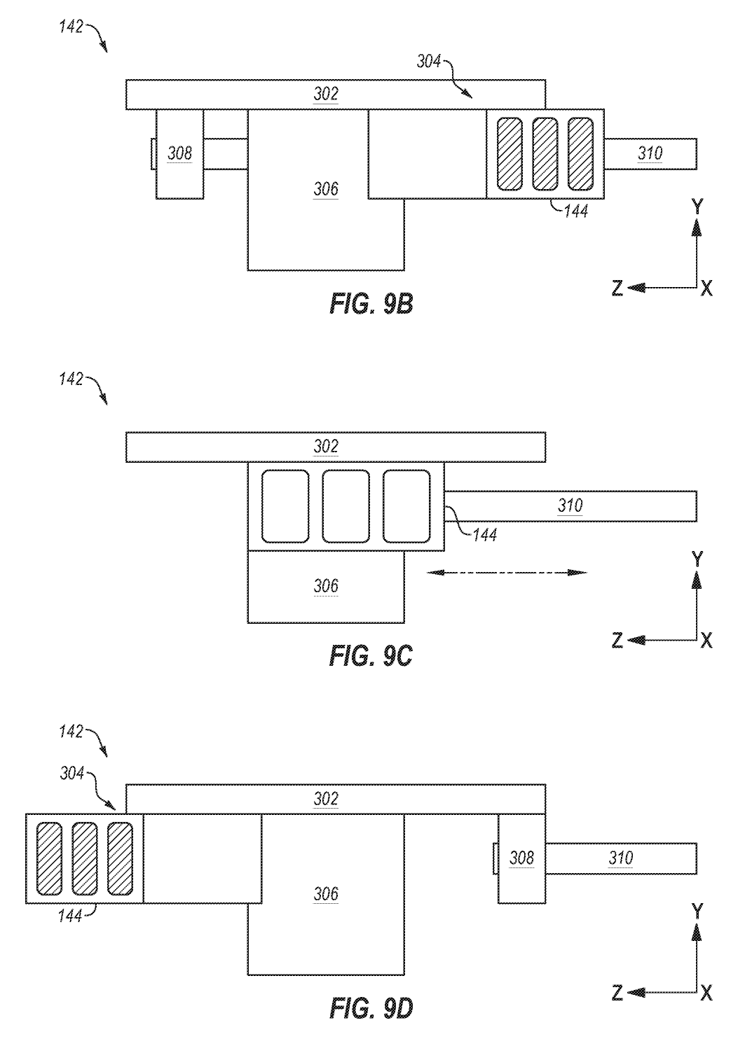

FIGS. 9A-9D are block diagrams of an example embodiment of the guidance structure 142 that may be implemented in the apparatus 100. The guidance structure 142 of FIGS. 9A-9D is configured to oscillate relative to the guidance arm 140. The guidance structure 142 is configured to oscillate from a first rotational position to a second rotational position. In FIG. 9A, a bottom view of the guidance structure 142 is shown. In FIG. 9B, a front view of the guidance structure 142 is shown in a first rotational position. In FIG. 9C, a front view of the guidance structure 142 is shown in an intermediate rotational position. In FIG. 9C, a front view of the guidance structure 142 is shown in a second rotational position.

The guidance structure 142 may include the receivers 144 that are mechanically coupled to a first end 304 of a disk 302. The disk 302 is mechanically coupled to an axel 306. The axel 306 is configured to rotatably couple to the guidance arm 140 of FIGS. 1A and 1B such that the disk 302 and the receivers 144 can rotate relative to the guidance arm 140. A disk connector 308 protrudes from a bottom surface of the disk 302.

The disk connector 308 interfaces with a push rod 310. With reference to FIGS. 2B and 9A-9D, the push rod 310 is driven in a z-direction and a negative z-direction by a rod motor 150. As the push rod 310 is driven in the z-direction and the negative z-direction, the disk 302 rotates from the first rotational position to the second rotational position and back. For example, with reference to FIG. 9B, the push rod 310 is positioned in a first end position in which the push rod 310 is moved in the z-direction. With the push rod 310 at the first end position, the guidance structure 142 is in the first rotational position. With reference to FIG. 9D, the push rod 310 is positioned in a second end position in which the push rod 310 is moved in the negative z-direction. With the push rod 310 at the second end position, the guidance structure 142 is in the second rotational position. With reference to FIG. 9C, the push rod 310 is positioned in an intermediate position between the first rotational position and the second rotational position. With the push rod 310 at the intermediate position, the guidance structure 142 is in an intermediate position. In the intermediate position, openings of the receivers 144 are substantially parallel to the YZ-plane. In the first rotational position and the second rotational position the openings of the receivers 144 are rotated relative to the YZ-plane.

### Spooling Function

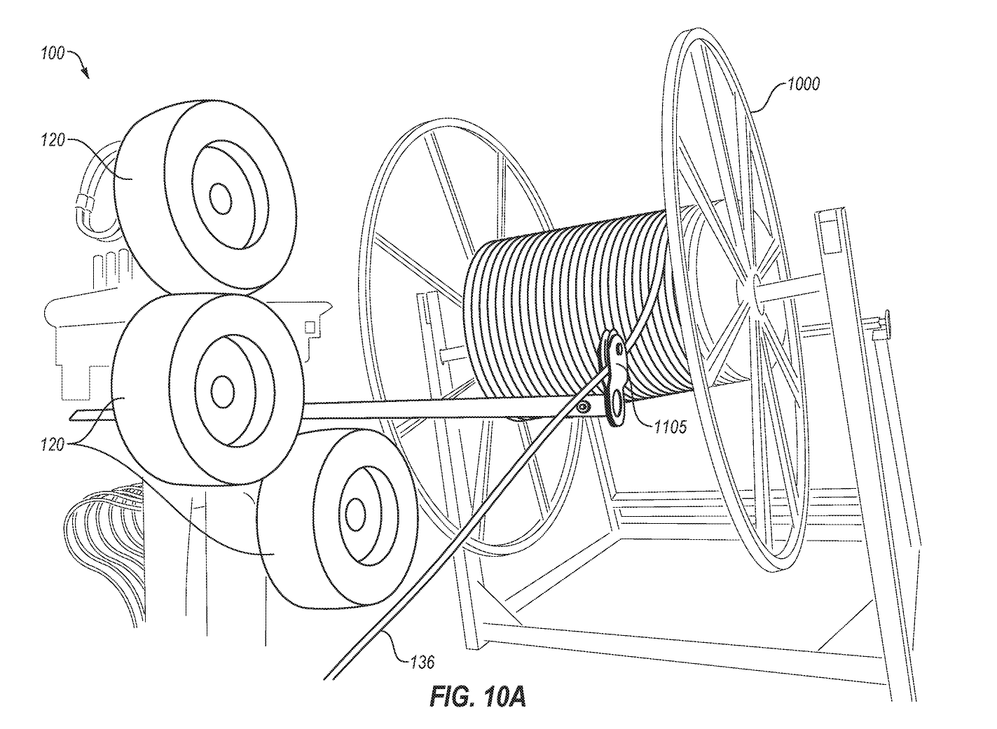

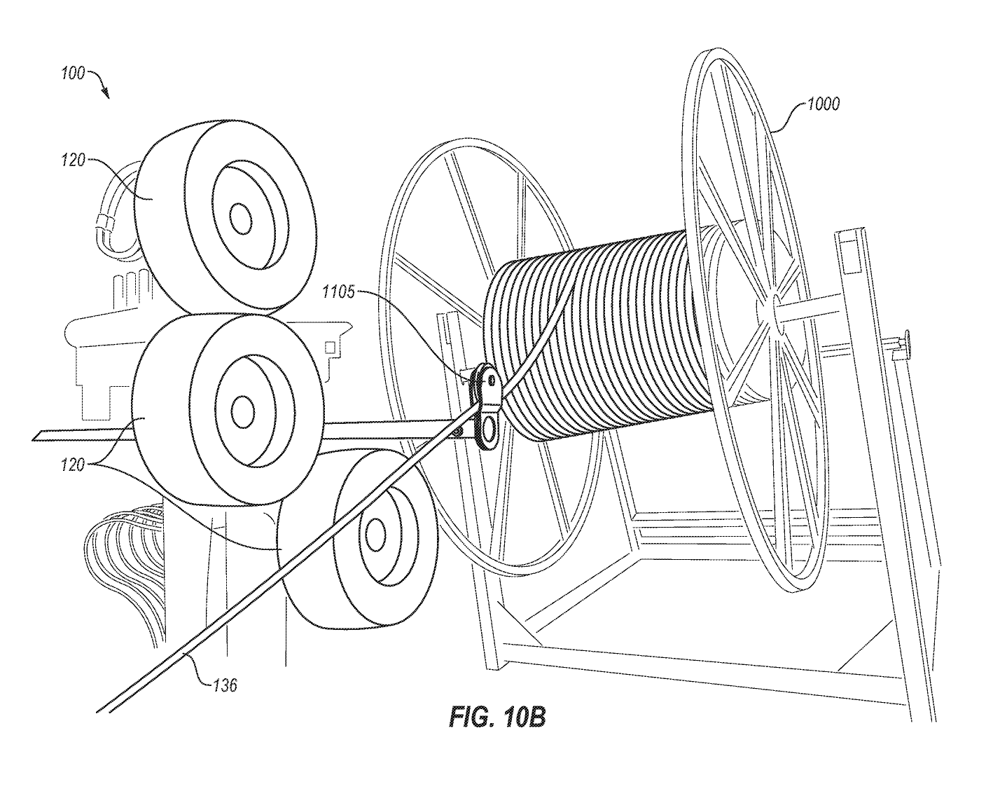

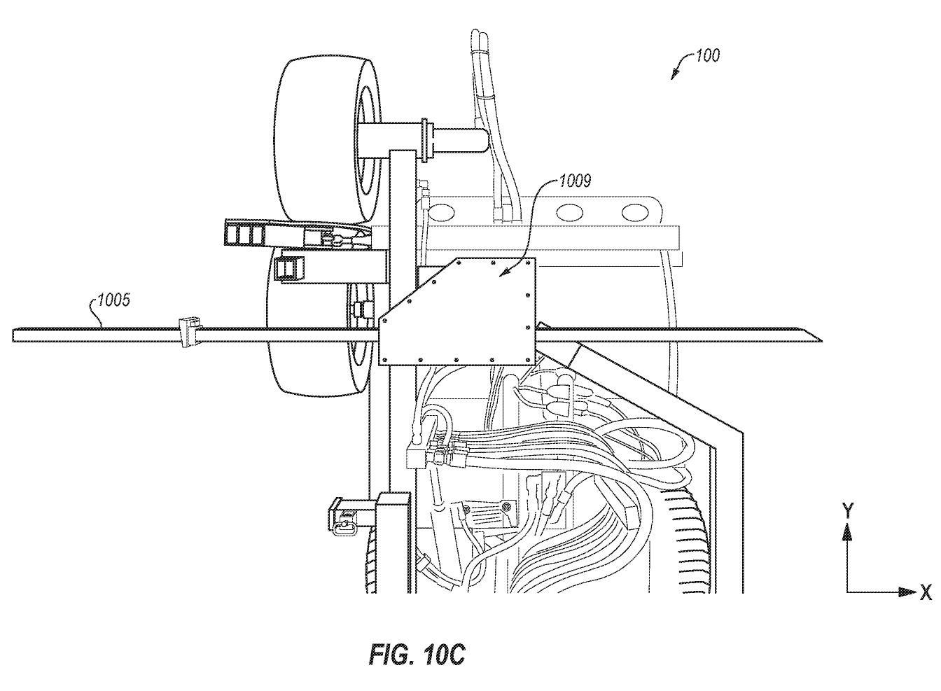

FIGS. 10A-10C depict the machine 50 configured with a spool to perform a spooling function. FIGS. 10A and 10B depict the machine with a spool 1000. FIG. 10C depicts a front view of the machine 50 with the fiber/conduit positioner 1005. In a spooling function configuration, the apparatus 100 may be configured as described with reference to FIG. 5. For example, the third cylindrical structure 120C may be in contact with the first cylindrical structure 120A. The second cylindrical structure 120B may be placed in contact with the first cylindrical structure 120A and a spool 1000. Accordingly, rotation of the third cylindrical structure 120C drives the second and first cylindrical structure 120A and 120B as well as the spool 1000. The fiber/conduit 136 may then be added to the spool 1000. To do so, the spool 1000 is rotated. As the spool 1000 is rotated, the fiber/conduit 136 is spooled onto the spool 1000.

A fiber/conduit positioner 1005 may be positioned in an oscillator device 1009. The fiber/conduit 136 may be routed through the fiber/conduit positioner 1005 as shown in FIGS. 10A and 10B. As the spool 1000 is rotated, the fiber/conduit positioner 1005 moves towards the cylindrical structures 120 and away from the cylindrical structures spool 1000 as seen in a comparison between FIG. 10A (the fiber/conduit positioner 1005 in farther from the cylindrical structures 120) and FIG. 10B (the fiber/conduit positioner 1005 in closer to the cylindrical structures 120). Accordingly, as the spool 1000 is rotated, the fiber/conduit positioner 1005 positions the fiber/conduit 136 along a length of the roller between the two spool ends. The combined rotation with the oscillation of the fiber/conduit positioner 1005 may enable a substantially even distribution of the fiber/conduit 136 along the length of the spool 1000.

FIG. 10C depicts the fiber/conduit positioner 1005 positioned in an oscillation device 1009. The oscillation device 1009 translates the fiber/conduit positioner 1005. In particular, the oscillation device 1009 translates the fiber/conduit positioner 1005 in an x-direction until a stop 1011 contacts the oscillation device 1009. The oscillation device 1009 then translates the fiber/conduit positioner 1005 in a negative x-direction. This may repeat until the fiber/conduit 136 is on the spool 1000 (FIGS. 10A and 10B).

The oscillation device 1009 may define an opening in which the fiber/conduit positioner 1005 is positioned. The oscillation device 1009 may include multiple rollers that translate the fiber/conduit positioner 1005. A pulley may be placed at the end of the fiber/conduit positioner 1005. The fiber/conduit 136 may be routed on the pulley. A stop that may be placed on the fiber/conduit positioner 1005, which may control or partially control the oscillation of the oscillation device 1009.

### Rate Adjustment Functions

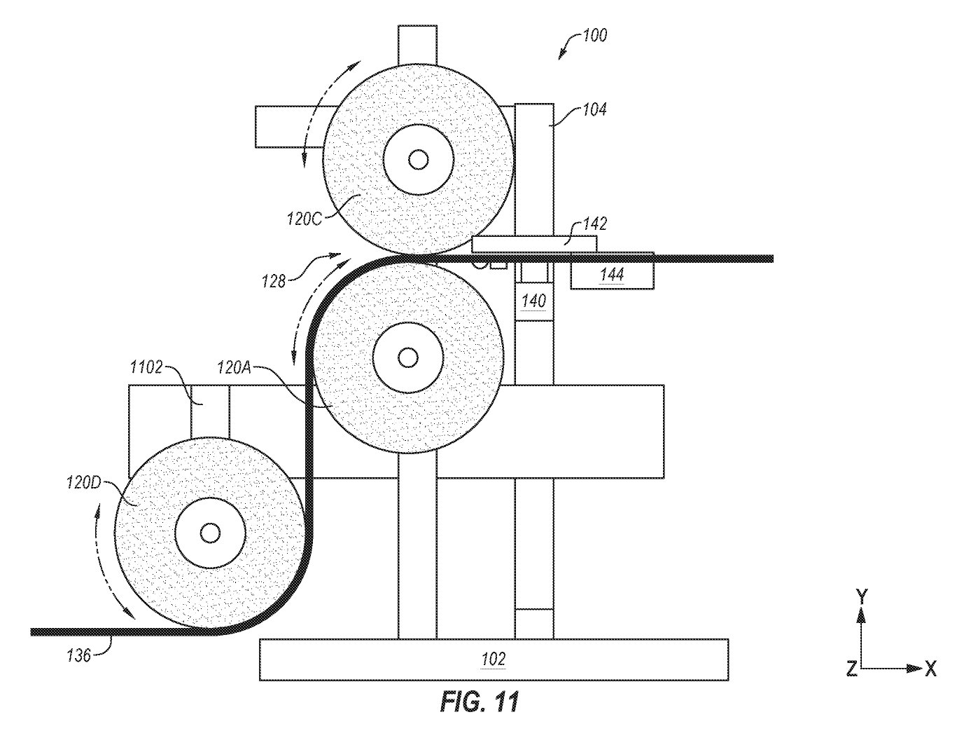

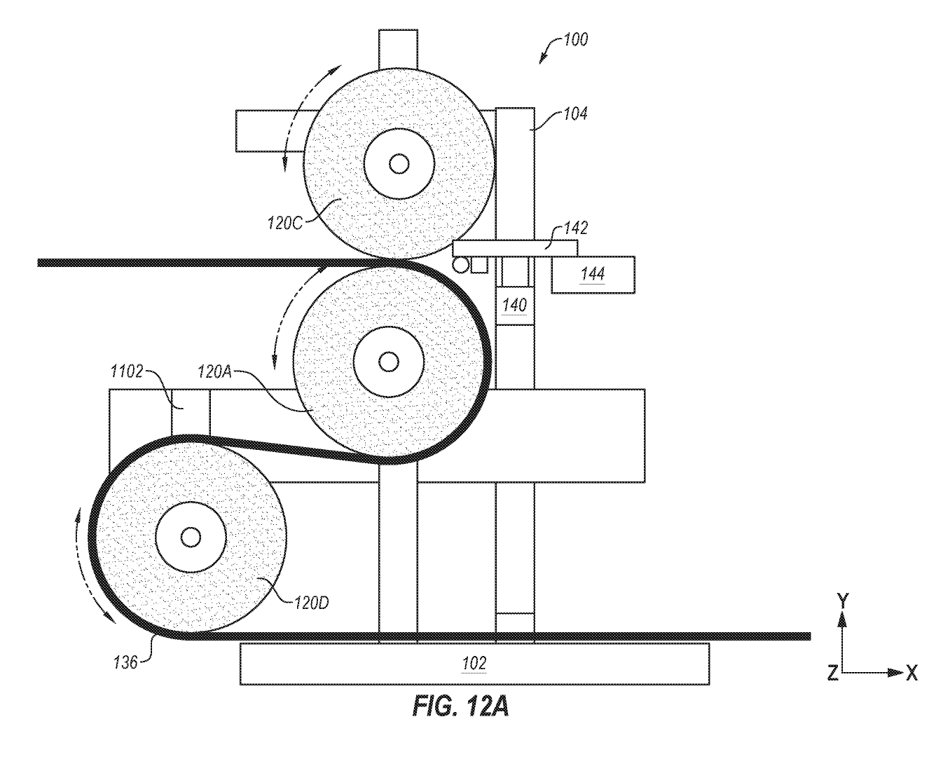

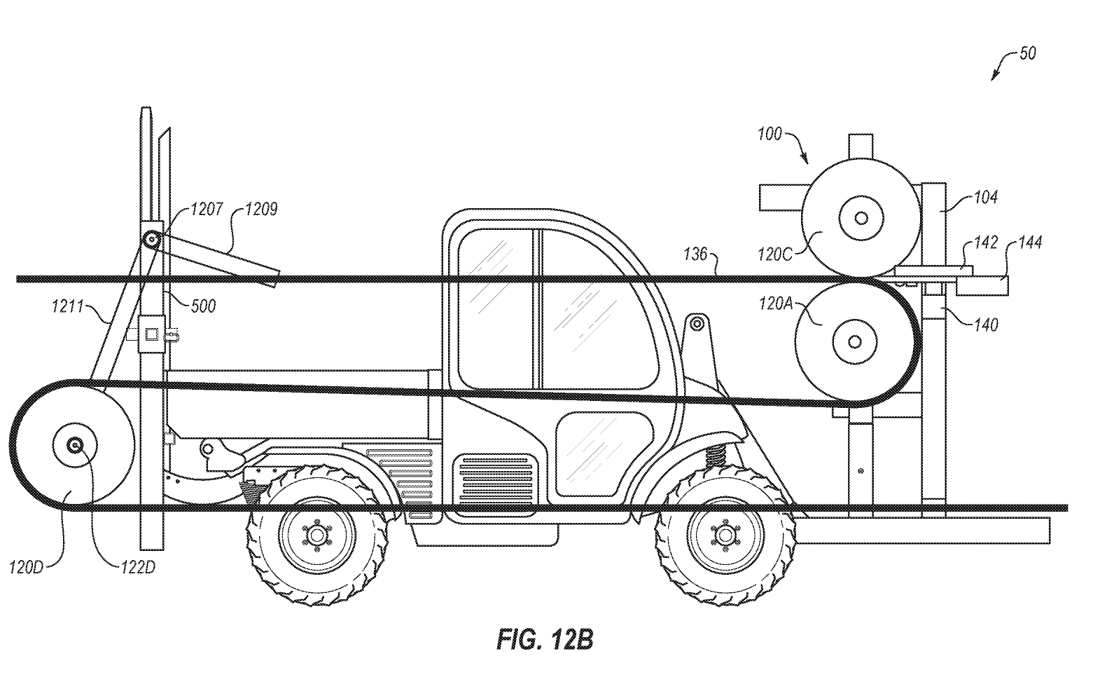

During installation and staging processes, a rate at which the fiber/conduit 136 is fed may be important. For instance, during installation processes, a rate that is too high may pull on optical fiber, which may damage the fiber. Accordingly, the apparatus 100 and the machine 50 may be configured to control rates at which one or more of the processes described herein. In particular, the apparatus 100 and the machine 50 may be configured to control the rate of each of the spooling function, the FIGURE-EIGHT function, the drive function, the pneumatic drive function, the corner drive function, and the manhole drive function. FIGS. 11, 12A, and 12B, depict the apparatus 100 and/or the machine 50 configured for rate adjustment and/or rate control functions.

FIG. 11 is a block diagram of the apparatus 100 configured for performance of a first rate adjustment function. In the first rate adjustment function configuration, the first and third cylindrical structures 120A and 120C are arranged as described with reference to FIG. 4. Another cylindrical structure 120D may positioned on a lever 1102. The fiber/conduit 136 may be routed around the cylindrical structure 120D then between the first and third cylindrical structures 120A and 120C.

The lever 1102 may be configured to determine whether rate at which the first and third cylindrical structures 120A and 120C are rotating is faster or slower than a particular rate. For instance, the lever 1102 may be rotated in the x-direction or the negative x-direction responsive to the rate at which the first and third cylindrical structures 120A and 120C rotate. The lever 1102 may be integrated with a controller and/or a feedback mechanism associated with the motor 124. The feedback mechanism and/or controller may send a signal to reduce or increase the rate of rotation of first and third cylindrical structures 120A and 120C. Accordingly, the rate at which the fiber/conduit 136 is fed is controlled, monitored, and adjusted in substantially real time.

FIG. 12A is a block diagram of the apparatus 100 configured for performance of a second rate adjustment function. In the second rate adjustment function configuration, the first and third cylindrical structures 120A and 120C are arranged as described with reference to FIG. 4. The other cylindrical structure 120D may positioned on the lever 1102. The fiber/conduit 136 may be routed between the first and third cylindrical structures 120A and 120C and then around the cylindrical structure 120D.

Similar to the arrangement of FIG. 11, the lever 1102 may be configured to determine whether rate at which the first and third cylindrical structures 120A and 120C are rotating is faster or slower than the particular rate. For instance, the lever 1102 may be rotated in the x-direction or the negative x-direction responsive to the rate at which the first and third cylindrical structures 120A and 120C rotate. The lever 1102 may be integrated with a controller (e.g., 52) and/or a feedback mechanism associated with the motor 124 to reduce or increase the rate of rotation of first and third cylindrical structures 120A and 120C.

FIG. 12B is a block diagram of the apparatus 100 configured for performance of the second rate adjustment function with the other cylindrical structure 120D in an alternative position. For instance, in the arrangement of FIG. 12B, the first and third cylindrical structures 120A and 120C are arranged as described with reference to FIG. 4. The other cylindrical structure 120D may positioned on the rear structure 500. The fiber/conduit 136 may be routed between the first and third cylindrical structures 120A and 120C and then around the cylindrical structure 120D. Instead of the lever 1102 being included on the apparatus 100 as in FIGS. 11 and 12A, a rear lever 1211 is rotatably attached to the rear structure 500. At a pivot 1207 or another suitable location, the controller and/or feedback mechanism may be integrated. The rear lever 1211 and the controller and/or feedback mechanism may be configured to determine whether rate at which the first and third cylindrical structures 120A and 120C are rotating is faster or slower than the particular rate. For instance, the rear lever 1211 may be rotated in the x-direction or the negative x-direction responsive to the rate at which the first and third cylindrical structures 120A and 120C rotate. The controller (e.g., 52) and/or a feedback mechanism associated with the motor 124 to reduce or increase the rate of rotation of first and third cylindrical structures 120A and 120C.

In some embodiments, the rear structure 500 may include a counterweight 1209. The counterweight may be configured to slow or dampen movement of the other cylindrical structure 120D. The counterweight 1209 may ensure that the fiber/conduit 136 remains taunt against a circumferential surface of the other cylindrical device 120D.

### Mower Function

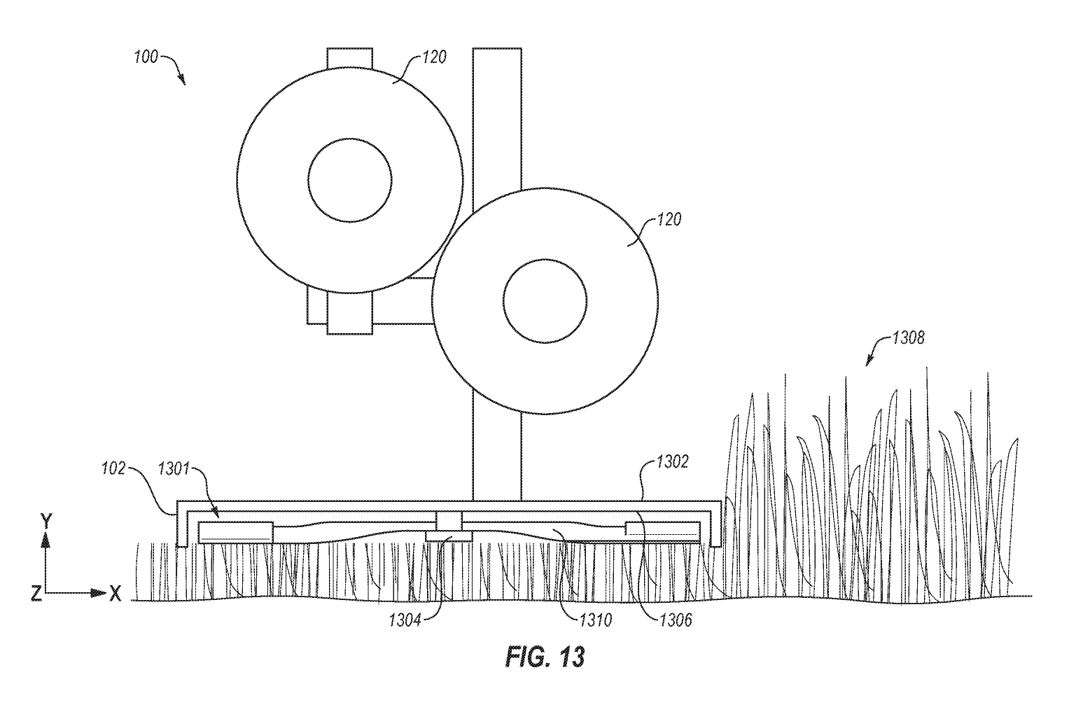

FIG. 13 depicts the apparatus 100 related to the apparatus arranged for a mower function. FIG. 13 is a block diagram of a portion of the apparatus 100 according to at least some embodiments described in this disclosure. FIG. 13 includes a sectional view of the base 102. The base 102 is a housing 1302 that defines a cavity 1301. A mower 1304 may be positioned in the cavity 1301 of the housing 1302. The mower 1304 may be coupled to a bottom surface 1306 of the base 102. The mower 1304 may be configured to trim or cut environmental vegetation 1308. For instance, the environmental vegetation 1308 may enter the housing 1302 that surrounds the mower 1304 and be trimmed by a rotating blade 1310 of the mower 1304.

The mower 1304 may be useful in circumstances in which the fiber/conduit is installed in an area in which the environmental vegetation 1308 exists. The mower 1304 may trim the environmental vegetation 1308 prior to installation of the fiber/conduit.

In the embodiment of FIG. 13, the mower 1304 includes a rotating blade 1310 that rotates about an axis that is substantially parallel to the y-axis. In other embodiments, the mower 1304 may include one or more reel blades. In the embodiment of FIG. 13, the mower 1304 may be hydraulically driven. Additionally or alternatively, the mower 1304 may be electrically driven or the apparatus 100 may include an engine that drives the mower.

### Computing System

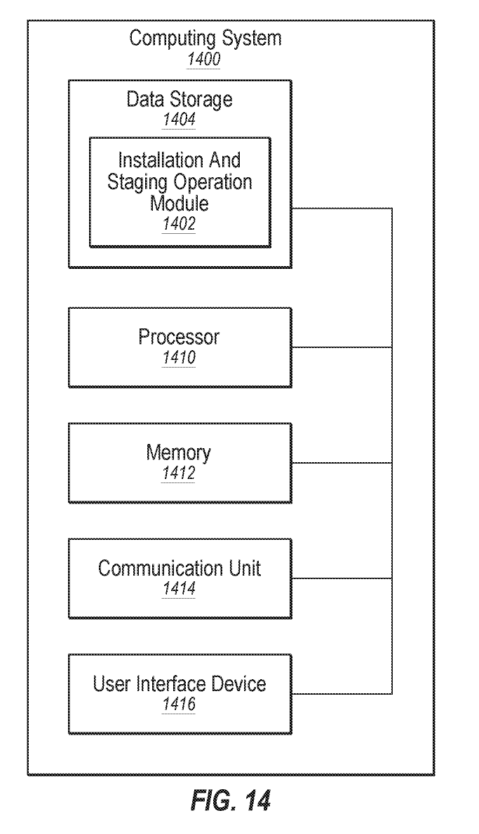

FIG. 14 illustrates an example computing system 1400 configured for fiber and conduit installation and staging processes according to at least one embodiment of the present disclosure. The computing system 1400 may be implemented in the machine 50 described herein. The computing system 1400 may include the controller computer 52. The computing system 1400 may include one or more processors 1410, a memory 1412, a communication unit 1414, the user interface device 1416, and a data storage 1404 that includes an installation and staging operation module 1402.

The installation and staging operation module 1402 may be configured to control the apparatus 100 and/or one or more components thereof through changes in states of electro-hydraulic components included therein. For example, response to user input, the installation and staging operation module 1402 may perform one or more of the functions described herein.

The processor 1410 may include any suitable special-purpose or general-purpose computer, computing entity, or processing device including various computer hardware or software modules and may be configured to execute instructions stored on any applicable computer-readable storage media. For example, the processor 1410 may include a microprocessor, a microcontroller, a digital signal processor (DSP), an ASIC, an FPGA, or any other digital or analog circuitry configured to interpret and/or to execute program instructions and/or to process data.

Although illustrated as a single processor in FIG. 14, the processor 1410 may more generally include any number of processors configured to perform individually or collectively any number of operations described in the present disclosure. Additionally, one or more of the processors 1410 may be present on one or more different electronic devices or computing systems. In some embodiments, the processor 1410 may interpret and/or execute program instructions and/or process data stored in the memory 1412, the data storage 1404, or the memory 1412 and the data storage 1404. In some embodiments, the processor 1410 may fetch program instructions from the data storage 1404 and load the program instructions in the memory 1412. After the program instructions are loaded into the memory 1412, the processor 1410 may execute the program instructions.

The memory 1412 and the data storage 1404 may include computer-readable storage media for carrying or having computer-executable instructions or data structures stored thereon. Such computer-readable storage media may include any available media that may be accessed by a general-purpose or special-purpose computer, such as the processor 1410. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 1410 to perform a certain operation or group of operations.

The communication unit 1414 may include one or more pieces of hardware configured to receive and send communications. In some embodiments, the communication unit 1414 may include one or more of an antenna, a wired port, and modulation/demodulation hardware, among other communication hardware devices. In particular, the communication unit 1414 may be configured to receive a communication from outside the computing system 1400 or from the user interface device 1416 and to present the communication to the processor 1410 or to send a communication from the processor 1410 to a component of the apparatus 100 or machine 50.

The user interface device 1416 may include one or more pieces of hardware configured to receive input from and/or provide output to a user. In some embodiments, the user interface device 1416 may include one or more of a speaker, a microphone, a display, a keyboard, a touch screen, or a holographic projection, among other hardware devices.

The installation and staging operation module 1402 may include program instructions stored in the data storage 1404. The processor 1410 may be configured to load the installation and staging operation module 1402 into the memory 1412 and execute the installation and staging operation module 1402. Alternatively, the processor 1410 may execute the installation and staging operation module 1402 line-by-line from the data storage 1404 without loading them into the memory 1412. When executing the installation and staging operation module 1402, the processor 1410 may be configured to perform a participation verification process as described elsewhere in this disclosure.

Modifications, additions, or omissions may be made to the computing system 1400 without departing from the scope of the present disclosure. For example, in some embodiments, the computing system 1400 may not include the user interface device 1416. In some embodiments, the different components of the computing system 1400 may be physically separate and may be communicatively coupled via any suitable mechanism. For example, the data storage 1404 may be part of a storage device that is separate from a server, which includes the processor 1410, the memory 1412, and the communication unit 1414, that is communicatively coupled to the storage device. The embodiments described herein may include the use of a special-purpose or general-purpose computer including various computer hardware or software modules, as discussed in greater detail below.

Terms used in the disclosure and in the appended claims (e.g., bodies of the appended claims) are generally intended as “open” terms (e.g., “including” should be interpreted as “including, but not limited to,” “having” should be interpreted as “having at least,” “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one,” “one or more,” “at least one of the following,” and “one or more of the following” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B. Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the example embodiments and the concepts contributed by the inventor to furthering the art, and are to be construed as being without limitation to such specifically-recited examples and conditions.

What is claimed is:

1. An optical fiber installation and staging apparatus, the apparatus comprising:
a base;
a support structure that is coupled to the base, wherein the support structure includes a fixed portion and a movable portion;
a first cylindrical structure that is mechanically coupled to the fixed portion of the support structure, the first cylindrical structure configured to rotate relative to the support structure;
a second cylindrical structure that is mechanically coupled to the movable portion, the second cylindrical structure configured to be mechanically rotated relative to the support structure and to traverse relative to the fixed portion of the support structure;
a guidance arm that is mechanically coupled to the fixed portion of the support structure;
a guidance structure that is positioned on the guidance arm; and
an interface created between at least a portion of a circumferential surface of the second cylindrical structure and at least a portion of a circumferential surface of the first cylindrical structure,
wherein:
the guidance structure is configured to receive an optical fiber or a conduit;
the second cylindrical structure is configured to traverse towards the first cylindrical structure to receive the optical fiber or the conduit in the interface; and
mechanical rotation of the second cylindrical structure causes rotation of the first cylindrical structure and a lateral motion of the optical fiber or the conduit received in the interface through the guidance structure.

2. The apparatus of claim 1, further comprising a hydraulic motor coupled to an axel of the second cylindrical structure, wherein the hydraulic motor is configured to cause the mechanical rotation of the first cylindrical structure.

3. The apparatus of claim 1, further comprising a turntable that enables a rotational positioning of the first and second cylindrical structures relative to a support vehicle.

4. The apparatus of claim 3, wherein the turntable is fixed to the base and includes a rotational gear that is driven by a hydraulic motor.

5. The apparatus of claim 1, further comprising a third cylindrical structure that is positioned relative to the second cylindrical structure such that a second interface is created between the third cylindrical structure and the second cylindrical structure,
wherein:
the optical fiber or the conduit is drawn from a source, routed over the third cylindrical structure, through the second interface, through the interface between the first and the second cylindrical structures, received in the guidance structure, and to a destination; and
the mechanical rotation draws the optical fiber or the conduit from the source to the destination.

6. The apparatus of claim 5, wherein axles of the first cylindrical structure, the second cylindrical structure, and the third cylindrical structure are substantially parallel.

7. The apparatus of claim 1, wherein the guidance structure is configured to oscillate relative to the guidance arm from a first rotational position to a second rotational position.

8. The apparatus of claim 7, further comprising a FIGURE-EIGHT guide that is configured to extend from the support structure, wherein:
the FIGURE-EIGHT guide includes an adaptor that is configured to be received by the guidance structure and the FIGURE-EIGHT guide defines a volume in which a fiber or a conduit is positioned during a FIGURE-EIGHT staging process; and
the second cylindrical structure is configured to drive a particular length of the optical fiber or the conduit as the guidance structure oscillates from the first rotational position to the second rotational position such that the fiber or the conduit is laid in a FIGURE-EIGHT pattern on a surface surrounding the apparatus.

9. The apparatus of claim 1, further comprising a pneumatic installer that defines a central volume in which the optical fiber or the conduit is positioned, wherein the pneumatic installer is configured to receive a pneumatic pressure and apply the pneumatic pressure to the optical fiber or the conduit.

10. The apparatus of claim 1, further comprising a mower that is coupled to a bottom surface of the base such that an environmental vegetation enters a housing surrounding the mower and interfaces with a rotating blade of the mower.

11. The apparatus of claim 1, further comprising a leveling subsystem, wherein the base is rotationally coupled to the support structure and the leveling subsystem is configured to rotate the support structure relative to the base.

12. A fiber and conduit installation machine comprising:
a support vehicle;
a rear structure mechanically attached to a first end of the support vehicle; and
the apparatus of claim 1 attached to a second end of the support vehicle.

13. The machine of claim 12, wherein the rear structure includes a D-ring into which the optical fiber or the conduit is positioned prior to routing through the interface.

14. The machine of claim 12, further comprising a third cylindrical structure that is coupled to the rear structure and oriented at about 90 degrees relative to the first and second cylindrical structures, wherein the optical fiber and the conduit is routed around a portion of the second cylindrical structure and through the interface.

15. The machine of claim 12, further comprising a controller computer that is configured to control a position of the first and second cylindrical structure and a rotational speed of the second cylindrical structure.

16. A fiber and conduit installation machine comprising:
a support vehicle;
a rear structure mechanically attached to a first end of the support vehicle; and
an optical fiber installation and staging apparatus, the apparatus comprising:
a support structure that includes a fixed portion and a movable portion;
a first cylindrical structure that is mechanically coupled to the support structure, the first cylindrical structure configured to rotate relative to the support vehicle;
a second cylindrical structure that is mechanically coupled to the support structure, the second cylindrical structure configured to be driven to rotate relative to the support vehicle and to traverse relative to the support structure; and
an interface created between at least a portion of a circumferential surface of the second cylindrical structure and at least a portion of a circumferential surface of the first cylindrical structure, the interface being created through traversal of the second cylindrical structure relative to the first cylindrical structure,
wherein mechanical rotation of the second cylindrical structure causes rotation of the first cylindrical structure.

17. The machine of claim 16, further comprising a turntable that enables a rotational positioning of the first and second cylindrical structures relative to the support vehicle, wherein the turntable is fixed to a base and includes a rotational gear that is driven by a hydraulic motor.

18. The machine of claim 16, further comprising a third cylindrical structure that is positioned relative to the second cylindrical structure such that a second interface is created between the third cylindrical structure and the second cylindrical structure and rotation of the second cylindrical structure causes rotation of the third cylindrical structure.

19. The machine of claim 18, further comprising an oscillation device having a positioner at one end, wherein:
the third cylindrical structure is configured to contact a spool such that rotation of the third cylindrical structure rotates the spool, and
as the spool rotates, oscillation of the oscillation device enables a substantially even distribution of an optical fiber or a conduit along a length of the spool.

20. The machine of claim 16, further comprising:
a guidance arm that is mechanically coupled to the support structure;
a guidance structure that is positioned on the guidance arm, wherein the guidance structure is configured to oscillate relative to the guidance arm from a first rotational position to a second rotational position;
a FIGURE-EIGHT guide that is configured to extend from the support structure,
wherein:
the FIGURE-EIGHT guide includes an adaptor that is configured to be received by the guidance structure and the FIGURE-EIGHT guide defines a volume in which a fiber or a conduit is positioned during a FIGURE-EIGHT staging process; and
the second cylindrical structure is configured to drive a particular length of an optical fiber or a conduit as the guidance structure oscillates from the first rotational position to the second rotational position such that the fiber or the conduit is laid in a FIGURE-EIGHT pattern on a surface surrounding the apparatus.
